(19) United States
(12) Patent Application Publication
(10) Pub. No.: US 2019/0270896 A1
(43) Pub. Date: Sep. 5, 2019

(54) REFRACTIVE INDEX-MATCHED ADDITIVES FOR PHOTO-CURABLE COMPOSITIONS

(71) Applicant: IMERYS FILTRATION MINERALS, INC., San Jose, CA (US)

(72) Inventors: Neil TREAT, San Jose, CA (US); Navin PATEL, Lompoc, CA (US)

(21) Appl. No.: 16/320,538

(22) PCT Filed: Jul. 21, 2017
(86) PCT No.: PCT/US17/43246

§ 371 Date: Jan. 25, 2019

Related U.S. Application Data
(60) Provisional application No. 62/367,402, filed on Jul. 27, 2016.

(51) Int. Cl. C09D 11/101; B33Y 10/00; B33Y 70/00; B29C 64/135; C09D 11/102; C09D 11/037

(52) U.S. Cl. CPC C09D 11/101; B33Y 10/00; B33Y 70/00; B29K 2105/16; C09D 11/102; C09D 11/037; B29C 64/135

(57) ABSTRACT

This disclosure describes a refractive index-matched photo-curable composition containing a photo-curable resin, and a refractive index-matched additive, in which a ratio of a refractive index of the additive to a refractive index of the photo-curable resin ranges from about 0.8:1 to about 1.2:1. Also disclosed herein is an additive-manufacturing process, including the steps of delivering the refractive index-matched photo-curable composition onto a working surface to obtain a pre-polymer deposit on the working surface, and applying photons to the pre-polymer deposit to obtain a polymer in the form of a section plane of a component. Also disclosed herein are a method for increasing the curing rate of a photo-initiated polymerization, and a method for improving the mechanical properties of a composite material.

### CLAIM FOR PRIORITY

This PCT International Application claims the benefit of priority of U.S. Provisional Application No. 62/367,402, filed Jul. 27, 2016, the subject matter of which is incorporated herein by reference in its entirety.

### FIELD OF DISCLOSURE

This application relates to materials technology in general and more specifically to the use of refractive index-matched materials that allow greater control in the additive manufacturing of composite materials.

### BACKGROUND OF THE INVENTION

Additive manufacturing processes for producing three dimensional (3D) articles are known in the field. Additive manufacturing processes employ computer-aided design (CAD) to build three-dimensional objects in a layer-by-layer fashion. The resulting three-dimensional objects may be formed from liquid resins, powders, or other materials.

Additive manufacturing has advanced so rapidly in the past several years that many in the field believe that it will ultimately replace traditional manufacturing techniques such as investment casting. One of the main benefits of additive manufacturing is that the layer-by-layer fabrication process allows for access to the inside of the part during its construction, which enables the incorporation of complex internal structures that can achieve a significant improvement in mechanical properties relative to the traditional manufacturing processes. Additive manufacturing also allows the artisan to rapidly move from 3D CAD models to a finished part, thus enabling more efficient prototyping.

One very promising additive manufacturing technique is photo-curable 3D printing, which now has an annual market size of $300 million and a 30% yearly growth. The most common photo-curable 3D printing methods are stereolithography (SLA), inkjet printing, and digital light processing (DLP).

SLA is a well-known process for rapidly producing models, prototypes and patterns, as well as functional parts in certain applications. SLA uses CAD data of an object to fabricate the object in an additive manner by producing thin cross-sections. The CAD data of the object is loaded into a computer capable of controlling a laser beam that traces the pattern of a cross section through a liquid radiation-curable resin composition. Curing of the resin composition forms a thin solid layer corresponding to a cross section of the object. The solidified layer is then re-coated with the resin and the laser beam traces another cross section to harden another layer of the solid on top of the previous layer. Due to limitations during the laser curing process, when initially formed, the resulting three-dimensional object is often not fully cured and, therefore, may need to be subjected to a post-curing step.

Inkjet printing is another type of computer printing that creates a digital image by propelling droplets of an ink onto paper, plastic or other substrates. In additive manufacturing processes involving inkjet printing, an inkjet print heads moves across a bed of powder, selectively depositing a liquid binding material. A thin layer of powder is then spread across the completed section of the object being fabricated, and the process is repeated with each layer adhering to the last. When the object is complete, unbound powder is removed in a process called “de-powdering” and may be reused. The de-powdered part may then optionally be subjected to various infiltrants or other treatments to produce properties desired in the final part.

DLP additive manufacturing employs a DLP projector capable of creating an image by microscopically small mirrors laid out in a matrix on a semiconductor chip (known as a digital micromirror device (DMD)). Each mirror represents one or more pixels in the projected image. Use of DLP to produce an image of a cross section of an object enables rapid and accurate 3D printing of three-dimensional objects. DLP processes employ liquid photopolymer resins to construct the object. For each cross-sectional layer of an object, the DMD projects patterned light that selectively exposes and hardens the resin. Because an entire layer is exposed with a single light pattern, faster build speeds are achieved independent of layer complexity. Projection optics can also be used to control the resolution on the image plane and to adjust the layer thickness, leading to smooth and accurate finished parts.

The mechanical properties of objects produced using additive manufacturing techniques are largely dictated by the makeup of the photo-curable resins used in the layer-by-layer production of the object. These photo-curable resins may be composed of various constituents including monomers, macromers, initiators and additives. Commonly, the mechanical properties of the finished parts are tuned by varying the chemical compositions and the proportions of the monomers and the macromers contained in the photo-curable resin.

One of the challenges associated with additive manufacturing by 3D printing is that there are a limited number of chemical substituents (i.e., monomers and macromers) that are economically available, which ultimately limits the range of mechanical properties. In the vast majority of photo-curable resins, the macromers are composed of different ratios of hard and soft segments, which to a certain extent allows for tuning of the mechanical properties of the fabricated object. For example, increasing the ratio of hard to soft segments will typically reduce the elasticity of the resulting part (i.e., percent tensile elongation), while increasing the tensile modulus, heat deflection temperature, and glass transition temperature.

Although in the field of plastic manufacturing it is common to employ fillers and other reinforcing agents to alter the mechanical properties of the object being manufactured, use of reinforcing agents imposes certain limitations in the context of additive manufacturing. Because most 3D printing methods employ photo-curable resins, it is necessary for the resins to be transparent to the curing radiation, so that effective curing of the layers can occur. The presence of traditional reinforcing agents such as fillers in photo-curable resin generally leads to opaqueness of the photo-curable resin, due to scattering of the radiation.

Scattering of radiation due to the presence of typical reinforcing agents in photo-curable resins is detrimental to the additive manufacturing process, because opaqueness of the resin can lead to inefficient or incomplete curing during the layer-by-layer deposition steps. A reduction of curing rate can significantly undermine the utility of 3D printing processes due to the relatively slow rate of layer deposition. It can also undermine the utility of 3D printing processes by limiting the thickness of the layers produced in each additive iteration.

As a consequence, it is often necessary to significantly reduce the rate of the individual deposition steps, or the thickness of the individual layers, when using non-transparent photo-curable resins. Furthermore, the opaqueness imparted by the presence of traditional reinforcing agents and pigments can lead to imperfections in the curing process that ultimately affect the integrity and mechanical properties of the fabricated object. For example, photo-curable resins that contain mineral pigments often exhibit relatively slow and ineffective curing as layer thickness is increased, which can lead to poor inter-layer bonding that can jeopardize the integrity of a 3D-manufactured object. For this reason, it is often necessary to employ organic coloring agents that can be tuned to minimize scattering of the curing radiation.

### SUMMARY OF THE INVENTION

The present inventors have recognized that a need exists to find alternative methods and materials allowing greater control over the mechanical and optical properties of objects fabricated using additive manufacturing techniques. Ideal methods and materials would allow for the presence of reinforcing agents and mineral pigments in photo-curable resins without significantly altering the optical characteristics of the photo-curable resins, and without jeopardizing the efficiency or effectiveness of photo curing during additive manufacturing.

The following disclosure describes the preparation and use of refractive index-matched photo-curable compositions that enable the additive manufacture of objects having improved mechanical and optical properties without jeopardizing the efficiency or effectiveness of the photo curing process. Embodiments of the present disclosure, described herein such that one of ordinary skill in this art can make and use them, include the following:

(1) Some embodiments relate to a refractive index-matched photo-curable composition, comprising: a photo-curable resin; and a refractive index-matched additive, wherein a ratio of a refractive index of the additive to a refractive index of the photo-curable resin ranges from about 0.8:1 to about 1.2:1;

(2) Some embodiments relate to an additive-manufacturing process, comprising: delivering the refractive index-matched photo-curable composition of paragraph (1) above onto a working surface to obtain a pre-polymer deposit on the working surface; and applying photons to the pre-polymer deposit to obtain a polymer in the form of a section plane of a component;

(3) Some embodiments relate to a method for increasing the curing rate of a photo-initiated polymerization, the method comprising: (a) selecting a photo-curable resin corresponding to a desired polymer; (b) obtaining a refractive index of the photo-curable resin; (c) selecting a refractive index-matched additive such that a ratio of a refractive index of the additive to the refractive index of the photo-curable resin ranges from about 0.8:1 to about 1.2:1; and (d) performing a refractive index-matched photo-polymerization of a composition comprising the photo-curable resin and the refractive index-matched additive to obtain the desired polymer, wherein a curing rate of the refractive index-matched photo-polymerization is greater than a curing rate of a non-index-matched photo-polymerization of the photo-curable resin performed in the absence of the refractive index-matched additive;

(4) Some embodiments relate to a method for improving the mechanical properties of a composite material, the method comprising: (a) selecting a pre-polymer mixture capable of undergoing photo-polymerization to form a desired polymer; (b) selecting a reinforcing additive capable of improving at least one mechanical property of a solid material formed from the desired polymer and the reinforcing additive; (d) obtaining a refractive index of the reinforcing additive; (e) adjusting the contents of the pre-polymer mixture to obtain a photo-curable resin, such that a ratio of the refractive index of the reinforcing additive to a refractive index of the photo-curable resin ranges from about 0.8:1 to about 1.2:1; and (f) performing a photo-polymerization of a composition comprising the photo-curable resin and the reinforcing additive to obtain a composite material, wherein: a refractive index of the pre-polymer mixture is different from the refractive index of the photo-curable resin; and a mechanical strength of the composite material is greater than a mechanical strength of the solid material.

Additional objects, advantages and other features of the present disclosure will be set forth in part in the description that follows and in part will become apparent to those having ordinary skill in the art upon examination of the following or may be learned from the practice of the present disclosure. The present disclosure encompasses other and different embodiments from those specifically described below, and the details herein are capable of modifications in various respects without departing from the present invention. In this regard, the description herein is to be understood as illustrative in nature, and not as restrictive.

### BRIEF DESCRIPTION OF THE DRAWINGS

Embodiments of this disclosure are explained in the following description in view of figures that show:

FIG. 1 shows a LENETA™ Chart comparing the opaqueness of a UV-curable resin (MakerJuice G+™, left side) versus the opaqueness of a refractive index-matched, perlite-containing UV-curable composition (MakerJuice G+™+17.8 wt. % of Phyllomat F™);

FIG. 2 shows a plot of thickness versus curing time for two different UV-curable samples cured with a 36 watt UV lamp over a period of 20 minutes; and

FIG. 3 shows the dimensions (as viewed from the top) of a dog bone-shaped mold.

### DETAILED DESCRIPTION

### Refractive Index-Matched Photo-Curable Composition

Embodiments of this disclosure include refractive index-matched (RI-matched) photo-curable compositions that enable the incorporation of significant quantities of at least one reinforcing additive or mineral pigment into a photo-curable resin without adversely impacting the performance of the photo-curable resin during additive manufacturing.

Some embodiments of the present disclosure relate to a refractive index-matched photo-curable composition containing a photo-curable resin and a refractive index-matched additive. The term “refractive index matched” (also abbreviated herein as “RI-matched”) means that the respective refractive indexes of the photo-curable resin and the additive are selected or modified such that a ratio of a refractive index of the additive to a refractive index of the photo-curable resin ranges from about 0.8:1 to about 1.2:1.

The term “photo-curable resin” relates to a composition containing at least one photo-polymerizable compound that undergoes polymerization under radical or ionic conditions following exposure to a radiation source. Polymers formed from the photo-curable resin may include polyolefins, polyamides, polycarbonates, polyimides, polyurethanes, polyethylenemines, polyoxymethylenes, polyesters, polyacrylates, polylactic acids, polysiloxanes and copolymers and blends thereof such as acrylonitrile-butadiene-styrene (ABS) copolymers, just to name a few. Polymers formed from the photo-curable resin may be thermoplastic polymers, thermoset polymers, or elastomeric polymers. The photo-curable resin may be in the form of a solid, a liquid, an emulsion or a paste.

In some embodiments the photo-curable resin is in the form of a pre-polymer mixture containing a photoinitiator, at least one of a monomer and a macromer, optionally at least one solvent, and optionally at least one additional (non-RI-matched) additive. The pre-polymer mixture may be in the form of a solid, a liquid, an emulsion or a paste.

Suitable photoinitiators include benzoin ethers, benzil ketals, α-dialkoxy acetophenones, α-hydroxy alkylphenones, α-amino alkylphenones, acyl phospine oxides, benzophenones, benzoamines, thioxanthones, thioxanthamines, just to name a few suitable classes.

In some embodiments the photoinitiators is selected from acetophenone, anisoin, anthraquinone, anthraquinone-2-sulfonic acid, sodium salt monohydrate, (benzene) tricarbonylchromium, benzil, 98% benzoin, benzoin ethyl ether, benzoin isobutyl ether, benzoin methyl ether, benzophenone, benzophenone/1-hydroxycyclohexyl phenyl ketone, 3,3′,4,4′-benzophenonetetracarboxylic dianhydride, 4-benzoylbiphenyl, 2-benzyl-2-(dimethylamino)-4′-morpholinobutyrophenone, 4,4′-bis(diethylamino)benzophenone, 4,4′-bis(dimethylamino)benzophenone, camphor quinone, 2-chlorothioxanthen-9-one, (cumene)cyclopentadienyliron(II) hexafluoro phosphate, dibenzosuberenone, 2,2-diethoxyacetophenone, 4,4′-dihydroxy benzophenone, 2,2-dmethoxy-2-phenylacetophenone, 4-(dimethylamino) benzophenone, 4,4′-dimethylbenzil, 2,5-dimethylbenzophenone, tech., 3,4-dimethyl benzophenone, diphenyl(2,4,6-trimethylbenzoyl)phosphine oxide/2-hydroxy-2-methyl propiophenone, 4′-ethoxyacetophenone, 2-ethylanthraquinone, ferrocene, 3′-hydroxy acetophenone, 4′-hyd roxyacetophenone, 3-hydroxybenzophenone, 4-hydroxy benzophenone, 1-hydroxycyclohexyl phenyl ketone, 2-hydroxy-2-methyl propiophenone, 2-methylbenzophenone, 3-methylbenzophenone, methybenzoyl formate, 2-methyl-4′-(methylthio)-2-morpholinopropiophenone, phenanthrenequinone, 4′-phenoxyacetophenone, thioxanthen-9-one, triarylsulfonium hexafluoroantimonate salts and triarylsulfonium hexafluorophosphate salts.

In some embodiments the photoinitiator is selected from benzophenone, methyl benzophenone, a xanthone, an acylphosphine oxide, a benzoin compound and a benzoin alkyl ether compound.

The term “refractive index” (RI) is used herein interchangeably with the term “index of refraction” and is a dimensionless parameter defined as the ratio (n) of the speed of light (c) over the phase velocity (v) of light in a medium being measured.

$$n = \frac{c}{v}$$

The refractive indexes of the photo-curable resin and the additive can be measured directly with a refractometer, or alternatively the difference (ratio) between the refractive indexes of the photo-curable resin and the additive (used in determining whether the materials are RI matched) can be assessed using the qualitative and/or qualitative measures as described below.

In some embodiments the refractive index of the photo-curable resin ranges from about 1.200 to about 1.800 depending upon the identity and proportions of the initiator, monomer(s) and/or macromer(s), and optional components such as solvents and additional additives in the pre-polymer mixture. In other embodiments the refractive index of the photo-curable resin ranges from about 1.300 to about 1.700, while in other embodiments the refractive index of the photo-curable resin ranges from about 1.400 to about 1.600. In some embodiments it may be preferable to employ a photo-curable resin having a refractive index ranging from about 1.450 to about 1.550.

In some embodiments the refractive index of the photo-curable resin depends upon the proportions and refractive indexes of the components making up the pre-polymer mixture (i.e., initiator, monomer(s), macromer(s), solvent(s), additional additive(s)). In some embodiments the refractive indexes of the components chosen to prepare the pre-polymer mixture are selected to be as close as possible to the intended refractive index of the photo-curable resin. Selecting components having refractive indexes as close as possible to the intended refractive index of the photo-curable resin allows more effective control of RI matching between the photo-curable resin and the RI-matched additive. In some embodiments the refractive indexes of the components chosen to prepare the pre-polymer mixture are selected such that their refractive indexes all fall within the ratio of the RI of the additive to the RI of the photo-curable resin (e.g., within the ratio from about 0.8:1 to about 1.2:1).

In some embodiments the total proportion of the monomer(s) and/or macromer(s) in the pre-polymer mixture is greater than about 50% by mass, relative to a total mass of the pre-polymer mixture. In other embodiments the total proportion of the monomer(s) and/or macromer(s) in the pre-polymer mixture is greater than about 60% by mass, or greater than about 70% by mass, or greater than about 80% by mass, or greater than about 80% by mass, or greater than about 90% by mass, or greater than about 95% by mass, or greater than about 98% by mass, relative to a total mass of the pre-polymer mixture.

In some embodiments, a relatively high proportion of the pre-polymer mixture is composed of a monomer, a macromer, or a combination thereof, such that the refractive index of the pre-polymer mixture is determined in large measure based on the refractive indexes of the monomer and/or the macromer. In some embodiments the refractive index of the pre-polymer mixture can be readily adjusted by altering the identity and/or relative proportions of the monomer and/or macromer in the pre-polymer mixture. By example, if a mineral additive contained in a photo-curable composition has a refractive index of 1.500, then a pre-polymer mixture may be formulated by choosing the identify and/or relative proportions of a monomer and/or macromer such that the refractive index of the resulting pre-polymer mixture ranges from about 1.250 to about 1.750. In such an embodiment it can be said that the mineral additive is RI-matched to the pre-polymer mixture (photo-curable resin), because the ratio of the RI of the mineral additive (1.500) to the RI of the photo-curable resin (1.250-1.750) ranges from about 0.8:1 to about 1.2:1.

In some embodiments the pre-polymer mixture contains a photoinitiator and at least one macromer, and does not include a monomer. In other embodiments the pre-polymer mixture contains a photoinitiator, at least one monomer, and at least one macromer. In other embodiments the pre-polymer mixture contains a photoinitator, at least one monomer, and does not include a macromer.

In some embodiments the pre-polymer mixture contains at least one class of monomers selected from the group consisting of a (meth)acrylate ester monomer, a (meth)acrylamide monomer, a (meth)acrylic acid monomer, a (meth)acrylonitrile monomer and a maleimide monomer. The prefix “(meth)” indicates that these monomer species include acrylo groups, methacrylo groups, or mixtures thereof.

In some embodiments the pre-polymer mixture comprises at least one monomer selected from the group consisting of an alkyl (meth) acrylate, a hydroxyl-containing (meth)acrylate, an amide-containing (meth)acrylate, an amino-containing (meth)acrylate, an epoxy-containing (meth)acrylate, a carboxylic acid-containing (meth)acrylate, a salt of a carboxylic acid-containing (meth)acrylate and mixtures thereof. In some embodiments the pre-polymer mixture comprises at least one alkyl (meth)acrylate containing an alkyl group selected from the group consisting of a methyl group, an ethyl group, an n-propyl group, an isopropyl group, an n-butyl group, an isobutyl group, a t-butyl group, a 2-ethylhexyl group, a lauryl group, a stearyl group, a cyclohexyl group, a phenyl group, a benzyl group and a phenylethyl group.

In some embodiments the pre-polymer mixture comprises at least one monomer selected from the group consisting of 2-hydroxyethyl acrylate, 2-hydroxyethyl methacrylate, 2-hydroxypropyl acrylate, and 2-hydroxypropyl methacrylate.

In some embodiments the pre-polymer mixture comprises at least one monomer selected from the group consisting of acrylamide, methacrylamide, N-methyl acrylamide, N-methyl methacrylamide, N-methylol acrylamide, N-methylol methacrylamide, N,N-dimethylol acrylamide, N-methoxymethyl acrylamide, N-methoxymethylmethacrylamide, N-phenyl acrylamide, N,N-diethylamino ethyl acrylate and N,N-diethylamino ethyl methacrylate.

In some embodiments the refractive index of the monomer(s) included in the pre-polymer mixture ranges from about 1.200 to about 1.800.

The term “macromer” refers to a oligomeric or polymeric compound containing a functional group capable of polymerizing under radical or ionic conditions. A macromer is essentially an assembly of pre-polymerized or oligomerized monomers that has been modified to enable it to act as a monomer due to the presence of at least one functional group capable of polymerizing under radical or ionic conditions. Macromers applicable to the present disclosure encompass oligomers and polymers having a wide range of molecular weights and containing polymerizable (often terminal) functional groups such as olefinic groups, (meth)acrylic groups or epoxy groups. In some embodiments, macromers of the present disclosure may include pre-polymers known and used in the field of materials technology.

Macromers of the present disclosure include for example addition macromers, condensation macromers and ring-opening macromers. Addition macromers contain at least one functional group that is reactive under addition polymerization conditions, and include, by non-limiting example, poly(oxyethylene) dimethacrylates and polystyrene acrylates, just to name a few. Condensation macromers contain at least one function group that is reactive towards condensation polymerization reactions, and include, by non-limiting example, polyurethane (meth)acrylates, polyethylene glycols, polypropylene glycols, polytetramethylene glycols, polybutadiene glycols, poly(oxypropylene) diamines, polybutadiene dicarboxylic acids and thiol-terminated liquid polymers, just to name a few. Ring-opening macromers contain at least one reactive cyclic function group that can undergo ring-opening polymerization, and include, by non-limiting example, poly(oxyethyelene) diepoxides, polystyrene epoxides, polybutadiene diepoxides and polybutadiene diazirdines, just to name a few.

In some embodiments the pre-polymer mixture contains a urethane (meth)acrylate compound as the macromer. In some embodiments the urethane (meth)acrylate compound may be obtained by reacting a hydroxy-terminated polyurethane with a (meth)acrylic acid or derivative thereof. In other embodiments the urethane (meth)acrylate compound may be obtained by reacting an isocyanate-terminated pre-polymer with a hydroxyalkyl (meth)acrylate.

As explained above, the refractive index of the photo-curable resin can be adjusted and modulated by altering the identity and proportions of monomer(s) and/or macromer(s) contained in the pre-polymer mixture. In some embodiments, fine tuning of the refractive index of the photo-curable resin is carried out by selecting a macromer having a refractive index as close as possible to the refractive index of the additive to be combined with the photo-curable resin, and including a high proportion (e.g., greater than 90% by mass) of the macromer in the pre-polymer mixture. In some embodiments, the additive is RI matched to the photo-curable resin by adjusting the refractive index of the macromer to be as close as possible (e.g., within 5 percent) to the refractive index of the additive. Such tuning of the refractive index of the macromer can be carried out by altering the monomer makeup of a co-polymeric macromer.

In some embodiments the refractive index of the macromer(s) included in the pre-polymer mixture ranges from about 1.200 to about 1.800.

For example, in some embodiments the refractive index of the photo-curable resin can be adjusted and modulated using a quantitative process based on the curing rate of the pre-polymer mixture versus the curing rate of the RI-matched photo-curable composition containing the additive. This quantitative process includes (i) formulating an initial pre-polymer mixture and measuring the refractive index of the initial pre-polymer mixture, (ii) measuring a curing rate of the initial pre-polymer mixture, (iii) preparing an initial photo-curable composition containing the initial pre-polymer mixture and an additive having a refractive index similar to the measured refractive index of the initial pre-polymer mixture, (iv) measuring the curing rate of the initial photo-curable composition, and comparing the curing rates of the initial pre-polymer mixture versus that of the initial photo-curable composition, (v) if the curing rates of the initial pre-polymer mixture and the initial photo-curable composition exceed an upper difference threshold, then altering the initial pre-polymer mixture by changing the identity and/or proportions of the monomer(s) and/or macromer(s) contained in the initial pre-polymer mixture to obtain a modified pre-polymer mixture, (vi) measuring a curing rate of the modified pre-polymer mixture, (vii) preparing a modified photo-curable composition containing the modified pre-polymer mixture and the same additive used in the initial pre-polymer mixture, (viii) measuring the curing rate of the modified photo-curable composition, and comparing the curing rates of the modified pre-polymer mixture versus that of the modified photo-curable composition, and (ix) repeating the steps (v)-(viii) if the curing rates of the modified pre-polymer mixture and the modified photo-curable composition exceed the upper difference threshold.

In some embodiments the RI-matched additive of the RI-matched photo-curable composition is a reinforcing additive or a mineral pigment. The term “reinforcing additive” refers to an additive that improves at least one mechanical property of a composite material formed by curing the RI-matched photo-curable composition. The term “mineral pigment” refers to an inorganic additive that imparts color to, or alters the color of, a composite material formed by curing the RI-matched photo-curable composition. The RI-matched additive may be an inorganic material or an organic material.

In some embodiments the RI-matched additive is a mineral selected from phenakite (Be₂SiO₄), willemite (Zn₂SiO₄), forsterite (Mg₂SiO₄), fayalite (Fe₂SiO₄), tephroite (Mn₂SiO₄), pyrope (Mg₃Al₂(SiO₄)₃), almandine (Fe₃Al₂(SiO₄)₃), spessartine (Mn₃Al₂(SiO₄)₃), grossular (Ca₃Al₂(SiO₄)₃), andradite (Ca₃Fe₂(SiO₄)₃), uvarovite (Ca₃Cr₂(SiO₄)₃), hydrogrossular (Ca₃Al₂Si₂O₈(SiO₄)₃₋ₘ(OH)₄ₘ), zircon (ZrSiO₄), thorite ((Th,U)SiO₄), perlite (Al₂SiO₅), andalusite (Al₂SiO₅), kyanite (Al₂SiO₅), sillimanite (Al₂SiO₅), dumortierite (Al_{6,5-7}BO₃(SiO₄)₃(O,OH)₃), topaz (Al₂SiO₄(F,OH)₂), staurolite (Fe₂Al₉(SiO₄)₄(O,OH)₂), humite ((Mg,Fe)₇(SiO₄)₃(F,OH)₂), norbergite (Mg₃(SiO₄) (F,OH)₂), chondrodite (Mg₅(SiO₄)₂(F,OH)₂), humite (Mg₇(SiO₄)₃(F,OH)₂), clinohumite (Mg₉(SiO₄)₄(F,OH)₂), datolite (CaBSiO₄(OH)), titanite (CaTiSiO₅), chloritoid ((Fe,Mg,Mn)₂Al₄Si₂O₁₀(OH)₄), mullite (aka Porcelainite)(AeSi₂O₁₃), hemimorphite (calamine) (Zn₄(Si₂O₇)(OH)₂.H₂O), lawsonite (CaAl₂(Si₂O₇)(OH)₂—H₂O), ilvaite (CaFe^{II}₂Fe^{III}O(Si₂O₇)(OH)), epidote (Ca₂(Al,Fe)₃O(SiO₄)(Si₂O₇)(OH)), zoisite (Ca₂Al₃O (SiO₄)(Si₂O₇)(OH)), clinozoisite (Ca₂Al₃O(SiO₄)(Si₂O₇)(OH)), tanzanite (Ca₂Al₃O(SiO₄) (Si₂O₇)(OH)), allanite (Ca(Ce,La,Y,Ca)Al₂(Fe^{II},Fe^{III})O(SiO₄)(Si₂O₇)(OH)), dollaseite (Ce)(CaCeMg₂AlSi₃O₁₁F(OH)), vesuvianite (idocrase) (Ca₁₀(Mg, Fe)₂Al₄(SiO₄)₅ (Si₂O₇)₂(OH)₄), benitoite (BaTi(Si₃O₉), axinite ((Ca,Fe,Mn)₃Al₂(BO₃)(Si₄O₁₂)(OH), beryl/emerald (Be₃Al₂(Si₆O₁₈), sugilite (KNa₂(Fe, Mn,Al)₂Li₃Si₁₂O₃₀), cordierite ((Mg,Fe)₂Al₃(Si₅AlO₁₈), tourmaline ((Na,Ca)(Al,Li,Mg)₃—(Al,Fe,Mn)₆ (Si₆O₁₈(BO₃)₃ (OH)₄), enstatite (MgSiO₃), ferrosilite (FeSiO₃), pigeonite (Ca_{0.25}(Mg,Fe)_{1.75}Si₂O₆), diopside (CaMgSi₂O₆), hedenbergite (CaFeSi₂O), augite ((Ca,Na)(Mg,Fe,Al) (Si,Al)₂O₆), jadeite (NaAlSi₂O₆), aegirine(acmite) (NaFe^{III}Si₂O₆), spodumene (LiAlSi₂O₆) wollastonite (CaSiO₃), rhodonite (MnSiO₃), pectolite (NaCa₂(Si₃O₈)(OH)), anthophyllite ((Mg,Fe)₇Si₈O₂₂(OH)₂), cummingtonite (Fe₂Mg₅Si₈O₂₂(OH)₂), grunerite (Fe₇SiO₂₂(OH)₂), tremolite (Ca₂Mg₅Si₈O₂₂(OH)₂), actinolite (Ca₂(Mg,Fe)₅Si₈O₂₂(OH)₂), hornblende ((Ca,Na)₂₋₃(Mg,Fe,Al)₅Si₆(Al,Si)₂O₂₂(OH)₂), glaucophane (Na₂Mg₃Al₂Si₈O₂₂(OH)₂), riebeckite (asbestos) (Na₂Fe^{II}₃Fe^{III}₂Si₈O₂₂(OH)₂), arfvedsonite (Na₃ (Fe,Mg)₄FeSi₈O₂₂(OH)₂), antigorite (Mg₃Si₂O₅(OH)₄), chrysotile (Mg₃Si₂O₅(OH)₄), lizardite (Mg₃Si₂O₅(OH)₄), halloysite (Al₂Si₂O₅(OH)₄), kaolinite (Al₂Si₂O₅(OH)₄), illite ((K, H₃O)(Al,Mg,Fe)₂(Si,Al)₄O₁₀[(OH)₂,(H₂O)]), montmorillonite ((Na,Ca)_{0.33} (Al,Mg)₂Si₄O₁₀(OH)₂.nH₂O), vermiculite ((MgFe,Al)₃(Al,Si)₄O₁₀(OH)₂.4H₂O), talc (Mg₃Si₄O₁₀ (OH)₂), sepiolite (Mg₄Si₆O₁₅(OH)₂.6H₂O), palygorskite (or attapulgite) ((Mg,A)₂Si₄O₁₀ (OH).4(H₂O)), pyrophyllite (Al₂Si₄O₁₀(OH)₂), biotite (K(Mg,Fe)₃(AlSi₃)O₁₀(OH)₂), muscovite (KAl₂(AlSi₃)O₁₀(OH)₂), phlogopite (KMg₃(AlSi₃)O₁₀(OH)₂), lepidolite (K(Li,Al)₂₋₃(AlSi₃)O₁₀(OH)₂), margarite (CaAl₂(Al₂Si₂)O₁₀(OH)₂), glauconite ((K, Na) (Al,Mg, Fe)₂(Si,Al)₄O₁₀(OH)₂), chlorite ((Mg, Fe)₃(Si,Al)₄O₁₀(OH)₂. (Mg,Fe)₃(OH)₆), quartz (SiO₂), tridymite (SiO₂), cristobalite (SiO₂), coesite (SiO₂), stishovite (SiO₂), microcline (KAlSi₃O₈), orthoclase (KAlSi₃O₈), anorthoclase ((Na,K)AlSi₃O₈), sanidine (KAlSi₃O₈), albite (NaAlSi₃O₈), oligoclase ((Na,Ca)(Si,Al)₄O₈(Na:Ca 4:1)), andesine ((Na,Ca)(Si,Al)₄O₈(Na:Ca 3:2)), labradorite ((Ca,Na)(Si,Al)₄O₈(Na:Ca 2:3)), bytownite ((Ca,Na)(Si,Al)₄O₈(Na:Ca 1:4)), anorthite (CaAl₂Si₂O), nosean (NaaAl₆Si₆O₂₄(SO₄)), cancrinite (Na₆Ca₂(CO₃,AlSi₆O₂₄).2H₂O), leucite (KAlSi₂O₆), nepheline ((Na,K) AlSiO₄), sodalite (Naa(AlSiO₄)₆Cl₂), hauyne ((Na,Ca)₄₋₈Al₆Si₆(O,S)24(SO₄,Cl)₁₋₂), lazurite ((Na,Ca)₈(AlSiO₄)₆(SO₄,S,Cl)₂), petalite (LiAlSi₄O₁₀), marialite (Na₄ (AlSi₃O₈)₃(Cl₂,CO₃,SO₄)), meionite (Ca₄(Al₂Si₂O₈)₃(Cl₂CO₃, SO₄)) analcime (NaAlSi₂O₆.H₂O), natrolite (Na₂Al₂Si₃O₁₀.2H₂O), erionite ((Na₂,K₂,Ca)₂Al₄Si₁₄O₃₆.15H₂O), chabazite (CaAl₂Si₄O₁₂.6H₂O) heulandite (CaAl₂Si₇O₁₈.6H₂O), stilbite (NaCa₂Al₅Si₁₃O₃₆.17H₂O), scolecite (CaAl₂Si₃O₁₀.3H₂O), and mordenite ((Ca,Na₂,K₂)Al₂Si₁₀O₂₄.7H₂O).

In some embodiments the RI-matched additive is selected from a silica, an alumina, a gypsum, a talc, a mica, a carbon black, a montmorillonite mineral, a chalk, a diatomaceous earth, bauxite, limestone, sandstone, an aerogel, a xerogel, a microsphere, a porous ceramic sphere, gypsum dihydrate, calcium aluminate, magnesium carbonate, a ceramic material, a pozzolanic material, a zirconium compound, a xonotlite, a calcium silicate, a perlite, a vermiculite, a hydrated or unhydrated hydraulic cement particle, a pumice, a zeolite, a kaolin, calcium phosphate, barium sulfate, sodium carbonate, magnesium sulfate, aluminum sulfate, magnesium carbonate, barium carbonate, calcium oxide, magnesium oxide, calcium sulfate, barium sulfate, lithium fluoride, and calcium carbonate.

In some embodiments the RI-matched additive is a reinforcing additive such as a a diatomaceous earth, a white earth, a silica (fumed silica, precipitated silica, crystalline silica, fused silica, dolomite, anhydrous silicic acid, hydrous silicic acid, amorphous spherical silica, etc.), a heavy calcium carbonate, a colloidal calcium carbonate, magnesium carbonate, a baked clay, a clay, a talc, bentonite, an organic bentonite, an aluminum fine powder, a flint powder, zinc oxide, an active zinc oxide, zinc powder, zinc carbonate, a Shirasu balloon, a glass micro balloon, an organic microballoon, and the like.

In some embodiments the RI-matched additive is selected from an inorganic filler such as a precipitated silica, a fumed silica, a crystalline silica, a fused silica, dolomite, a carbon black, calcium carbonate, talc and the like.

In some embodiments an RI-matched photo-curable composition having a high transparency may be obtained by employing an RI-matched additive selected from a fumed silica, a precipitated silica, an anhydrous silicic acid, a hydrous silicic acid, a carbon black, an aluminosilicate, a surface-treated fine calcium carbonate, a crystalline silica, a fused silica, a baked clay, an active zinc oxide and the like. Among these examples, particles having a specific surface area (determined according to BET adsorption process) of no less than 10 m²/g, usually 50 to 400 m²/g, and approximately 100 to 300 m²/g may optionally be chosen.

In some embodiments the RI-matched additive is selected from a metal oxide, a metal silicate, a metal sulfate, a metal carbonate, an metal oxosulfate, a metal phosphate, a metal phosphonate, and mixtures thereof. In some embodiments the RI-matched additive is a silicate or an aluminosilicate of an alkali or alkaline earth metal. In some embodiments the RI-matched additive is an aluminosilicate, such as a thermally activated aluminosilicate. In some embodiments the RI-matched additive is perlite.

In some embodiments the RI-matched additive is a mineral pigment selected from a metal-based pigment or a carbon-based pigment. In some embodiments the RI-matched additive is a mineral pigment selected from the group consisting of an aluminum pigment, an arsenic pigment, a barium pigment, a cadmium pigment, a chromium pigment, a cobalt pigment, a copper pigment, an iron oxide pigment, a lead pigment, a manganese pigment, a mercury pigment a titanium pigment, a zinc pigment or a carbon pigment.

In some embodiment the RI-matched additive is a mineral pigment selected from ultramarine violet (Na₈₋₁₀Al₆Si₆O₂₄S₂₋₄), han purple (BaCuSi₂O₆), cobalt violet (cobaltous orthophosphate), manganese violet (NH₄MnP₂O₇), cobalt blue (cobalt(II) stannate), cerulean blue (cobalt(II) stannate), egyptian blue (CaCuSi₄O₁₀), han blue (BaCuSi₄O₁₀), prussian blue (Fe,(CN)₁₈), YInMn blue (YIn₁₋ₓMnₓO₃), cadmium green (a mixture of cadmium tellow (CdS) and viridian (Cr₂O₃)), chrome green (Cr₂O₃), viridian (Cr₂O₃.H₂O), azurite (Cu₃(CO₃)₂(OH)₂), malachite (Cu₂CO₃(OH)₂), paris green (Cu(C₂H₃O₂)₂.3Cu(AsO₂)₂), scheele's green (CuHAsO₃), verdigris (a mixture of cupric acetate (Cu(CH₃CO₂)₂) and malachite (Cu₂CO₃(OH)₂), orpiment (As₂S₃), cadmium yellow (CdS), chrome yellow (mate (PbCrO₄), aureolin (also called cobalt yellow) ((Na₃Co(NO₂)₆), yellow ochre (Fe₂O₃.H₂O), naples yellow, titanium yellow, mosaic gold (SnS₂), cadmium orange, chrome orange (PbCrO₄+PbO), cadmium red (CdSe), sanguine, caput mortuum, venetian red, oxide red, red ochre (anhydrous Fe₂O₃), burnt sienna, red lead (Pb₃O₄), vermilion (HgS), raw umber, raw sienna, carbon black, ivory black, vine black, lamp black, Iron black (Fe₃O₄), titanium black (Ti₂O₃), antimony white (Sb₂O₃), barium sulfate (BaSO₂), cremnitz white ((PbCO₃)₂′Pb(OH)₂), titanium white (TiO₂), and zinc white (ZnO).

In some embodiments it can be important to perform a surface modification of the RI-matched additive to improve compatibility between the RI-matched additive and the photo-curable resin. Surface modification generally involves performing a coating process on the RI-matched additive using a surface modification agent to provide a thin coating of an organic material containing functional groups that are reactive towards photo polymerization. The presence of the reactive functional groups on a coating surrounding the RI-matched additive improves the incorporation of the RI-matched additive into the composite material formed during photopolymerization of a photo-curable resin composition.

The term “surface modification agent” generally refers to a reactive or non-reactive compound containing a hydrophobic and/or oleophobic group including at least one functional group that can chemically react or interact and bond with reactive groups present on the surface of the RI-matched additive on the one hand, and at least one hydrophobic and/or oleophobic group that can chemically react or interact and bond with the photo-curable resin on the other. Bonding can be established via chemical bonding, e.g., covalent, including coordinative bonds (complexes) or ionic (salt-like) bonds of the functional group with the surface groups of the RI-matched additive, while interactions can include dipole-dipole interactions, polar interactions, hydrogen bridge bonds and van der Waals interactions. The formation of a chemical bond is preferred. For example, an acid/base reaction, complex formation or esterification can take place between the functional groups of the surface modification agent and the RI-matched additive.

Examples of suitable surface modification agents are mono- and polycarbonic acids, corresponding acid anhydrides, acid chlorides, esters and acid amides, alcohols, alkyl halides, amino acids, imines, nitriles, isonitriles, epoxy compounds, mono- and polyamine, dicarbonyl compounds, silanes and metal compounds, which have a functional group that can react with the surface groups of the RI-matched additive, which each have a hydrophobic and/or oleophobic group. In some embodiments the surface modification agents containing a hydrophobic and/or oleophobic group are silanes, carbonic acids, carbonic acid derivatives, like acid anhydrides and acid halides, in particular acid chlorides, alcohols, alkyl halides, like alkyl chlorides, alkyl bromides and alkyl iodides, wherein the alkyl residue can be substituted, in particular with fluorine. In some embodiments one or more surface modification agents can be used to surface modify the RI-matched additive.

Examples of hydrophobic and/or oleophobic groups are listed above. The functional group contained within the surface modification agent can involve carbonic acid groups, acid chloride groups, ester groups, nitrile and isonitrile groups, OH groups, alkyl halide groups, SH groups, epoxide groups, anhydride groups, acid amide groups, primary, secondary and tertiary amino groups, Si—OH groups or hydrolysable residues of silanes (Si—X groups described below) or C—H-acid groups, like dicarbonyl compounds. The surface modification agent can also encompass more than one such functional group, e.g., in amino acids or EDTA.

Suitable hydrophobic and/or oleophobic groups include the aforementioned, in particular long-chain aliphatic hydrocarbon groups, e.g., with 1 to 30 or more carbon atoms, in particular alkyl groups, aromatic groups, or groups exhibiting at least one fluorine atom, wherein these are preferably hydrocarbon groups, in particular alkyl residues, with 1 to 20 or more carbon atoms and 1 to 41 fluorine atoms.

Suitable surface modification agents include hydrolysable silanes with at least one non-hydrolysable hydrophobic and/or oleophobic group. Especially preferred here are hydrolysable silanes that exhibit at least one non-hydrolysable group, which is hydrophobic and/or oleophobic, in particular a group that contains at least one fluorine atom (fluorosilanes) or a long-chain aliphatic hydrocarbon group, e.g., with 1 to 30 carbon atoms, preferably an alkyl group, or an aromatic group.

In some embodiments the RI-matched additive is surface modified using a surface modification agent selected from an organosilane, an organotitanate, an organozirconate, an organoacid, an organoamine, an organothiol and a phosphinic compound.

In some embodiments the surface modification agent is at least one organosilane selected from [2-(3-cyclohexenyl)ethyl]trimethoxysilane, trimethoxy(7-octen-1-yl) silane, isooctyl trimethoxy-silane, N-(3-triethoxysilylpropyl) methoxy ethoxyethoxyethyl carbamate, N-(3-triethoxysilylpropyl)methoxyethoxyethoxyethyl carb amate, 3-(methacryloyloxy)propyltrimethoxysilane, allyl trimethoxysilane, 3-acryloxy propyltrimethoxysilane, 3-(methacryloyloxy)propyltriethoxysilane, 3-(methacryloyloxy) propylmethyldimethoxysilane, 3-acryloyloxypropyl)methyldimethoxysilane, -9-3-(meth acryloyloxy)propyldimethylethoxysilane, 3-(methacryloyloxy) propyldimethyl ethoxy silane, vinyldimethylethoxysilane, phenyltrimethoxysilane, n-octyltrimethoxy silane, dodecyltrimethoxysilane, octadecyltrimethoxysilane, propyltrimethoxysilane, hexyl trimethoxysilane, vinylmethyldiacetoxysilane, vinylmethyldiethoxysi lane, vinyltriacetoxy silane, vinyltriethoxysilane, vinyltriisopropoxysilane, vinyltrimethoxysilane, vinyltri phenoxysilane, vinyltri-tbutoxysilane, vinyltris-isobutoxysilane, vinyltriisopropenoxy silane, vinyltris(2-methoxyethoxy)silane, styrylethyltrimethoxysilane, mercaptopropyl trimethoxysilane, 3-glycidoxypropyltrimethoxysilane, acrylic acid, methacrylic acid, oleic acid, stearic acid, dodecanoic acid, 2-[2-(2-methoxyethoxy)ethoxy]acetic acid (MEEAA), betacarboxyethylacrylate, 2-(2-methoxyethoxy)acetic acid, methoxyphenyl acetic acid, and combinations of two or more thereof.

In some embodiments the surface modification agent is at least one selected from vinyltrimethoxysilane, vinyltriethoxysilane, γ-aminopropyltrimethoxysilane, γ-aminopropyl methyldimethoxysilane, γ-aminopropyldimethylmethoxysilane, γ-amino propyltriethoxysilane, γ-aminopropylmethyldiethoxysilane, γ-aminopropyldimethyl ethoxysilane, methyltriethoxysilane, dimethyldimethoxysilane, trimethylmethoxysilane, hexyltrimethoxysilane, hexyltriethoxysilane, octadecyltrimethoxysilane, octadecyl triethoxysilane, γ-methacryloxypropylmethyldimethoxysilane, γ-methacryloxypropyl methyldiethoxysilane, γ-methacryloxypropyltrimethoxysilane and γ-methacryloxypropyl triethoxysilane. These silane compounds may be used solely or in combination of two or more of them.

In some embodiments the RI-matched additive is a surface-modified mineral in the form of an engineered aluminosilicate obtained by reacting an acrylate-functional silane with an aluminosilicate that is refractive index matched to the photo-curable resin. In some embodiments the RI-matched additive is a surface-modified mineral in the form of an engineered aluminosilicate formed by reacting (3-acryloxy propyl)trimethoxysilane with an aluminosilicate that is refractive index matched to the photo-curable resin.

In some embodiments the RI-matched additive has a median particle size (d₅₀) of greater than or equal to about 0.5 μm, such as, for example, greater than or equal to about 1 μm, greater than or equal to about 3 μm, greater than or equal to about 5 μm, greater than or equal to about 7 μm, greater than or equal to about 9 μm, greater than or equal to about 10 μm, greater than or equal to about 11 μm, greater than or equal to about 12 μm, greater than or equal to about 13 μm, greater than or equal to about 14 μm, or greater than or equal to about 15 μm. In other embodiments, the RI-matched additive has a median particle size (d₅₀) ranging from about 1 μm to about 15 μm, such as, for example, from about 1 μm to about 5 μm, from about 5 μm to about 10 μm, from about 10 μm to about 15 μm, from about 1 μm to about 3 μm, from about 3 μm to about 6 μm, from about 6 μm to about 9 μm, from about 9 μm to about 12 μm, or from about 12 μm to about 15 μm.

The particle sizes of the various particles of the present disclosure were measured according to the methods know to the skilled person in the art using light scattering of the particulate materials in a fully dispersed condition in an aqueous medium using a Microtrac S₃₅₀₀ laser diffraction machine supplied by Microtrac, a member of Nikkiso. The size of the particles is referred to as the “equivalent spherical diameter” (esd). The measured particle size can be provided as a plot of the cumulative percentage by weight of particles having a given size less than the esd values. The median particle size, d₅₀, is the value determined to be the esd at which 50% of the particles by weight have an esd less than that of the particular value.

In some embodiments the particle sizes of the RI-matched additive and particles included in the photo-curable resin are controlled in order to ensure that the RI-matched photo-curable composition remains in the form of a homogeneous dispersion or solution over a given timeframe necessary to transport, store and use the RI-matched photo-curable composition. For example, the particles sizes of the RI-matched additive and particles included in the photo-curable resin are controlled such that the RI-matched photocurable composition remains in the form of a homogenous dispersion or solution for a period of at least 30 days, or at least 20 days, or at least 10 days. In some embodiments in which the RI-matched photo-curable composition is generated in situ, the particles sizes of the RI-matched additive and particles included in the photo-curable resin are controlled such that the RI-matched photocurable composition remains in the form of a homogenous dispersion or solution for a period of at least 10 days, or at least 1 day, or at least 12 hours, or at least 1 hour.

In some embodiments the RI-matched additive has a BET surface area of greater than or equal to about 3.0 m²/g. For example, the RI-matched additive may have a BET surface area greater than or equal to about 10 m²/g, greater than or equal to about 50 m²/g, greater than or equal to about 75 m²/g, greater than or equal to about 90 m²/g, greater than or equal to about 100 m²/g, greater than or equal to about 150 m²/g, greater than or equal to about 200 m²/g, greater than or equal to about 250 m²/g, or greater than or equal to about 300 m²/g. In other embodiments the RI-matched additive may have a BET surface area ranging from about 3.0 m²/g to about 300 m²/g. For example, the RI-matched additive may have a BET surface area in a range from about 10 m²/g to about 100 m²/g, from about 100 m²/g to about 300 m²/g, from about 50 m²/g to about 150 m²/g, from about 10 m²/g to about 50 m²/g, from about 3 m²/g to about 25 m²/g, from about 150 m²/g to about 250 m²/g, from about 200 m²/g to about 300 m²/g, or from about 100 m²/g to about 200 m²/g.

“BET surface area,” as used herein, refers to the technique for calculating specific surface area of physical absorption molecules according to Brunauer, Emmett, and Teller (“BET”) theory. BET surface area can be measured, for example, with an ASAP® 2460 Surface Area and Porosimetry Analyzer using nitrogen as the sorbent gas, available from Micromeritics Instrument Corporation (Norcross, Ga., USA).

In some embodiments the RI-matched additive may have an aspect ratio in the range of from about 1 to about 50, such as for example from about 1 to about 25, or from about 1.5 to about 20, or from about 2 to about 10. The aspect ratio may be determined according to Jennings theory. The Jennings theory (or Jennings approximation) of aspect ratio is based on research performed by W. Pabst, E. Gregorova, and C. Berthold, Department of Glass and Ceramics, Institute of Chemical Technology, Prague, and Institut für Geowissenschaften, Universitit Tübingen, Germany, as described, e.g., in Pabst W., Berthold C.: Part. Part. Syst. Charact. 24 (2007), 458.

In some embodiments the RI-matched additive may have an oil absorption of greater than or equal to about 300 wt %, such as, for example, greater than or equal to about 320 wt %, greater than or equal to about 350 wt %, greater than or equal to about 370 wt %, greater than or equal to about 400 wt %, greater than or equal to about 420 wt %, or greater than or equal to about 450 wt %. To attain such levels of oil absorption, in some embodiments the RI-matched additive is subject to surface modification as described above.

In some embodiments the RI-matched additive may have a water absorption of greater than or equal to about 400 wt %, such as, for example, greater than or equal to about 420 wt %, greater than or equal to about 450 wt %, greater than or equal to about 470 wt %, greater than or equal to about 500 wt %, greater than or equal to about 520 wt %, greater than or equal to about 550 wt %, or greater than or equal to about 570 wt %. To attain such levels of water absorption, in some embodiments the RI-matched additive is subject to surface modification as described above.

The proportion of the RI-matched additive in the RI-matched photo-curable composition ranges from about 0.001% by mass to about 25% by mass, relative to a total mass of the RI-matched photo-curable composition. The proportion of the RI-matched additive in the RI-matched photocurable composition may be adjusted to affect the morphology, color and mechanical characteristics of a composite material formed by photopolymerizing the RI-matched photo-curable composition. Thus, in some embodiments the physical characteristics of a component formed by an additive manufacturing process using the RI-matched photo-curable compositions can be greatly affected by the proportion of the RI-matched additive in the RI-matched photo-curable composition.

In some embodiments the proportion of the RI-matched additive in the RI-matched photo-curable composition ranges from about 0.001% by mass to about 25% by mass, or from about 0.01% by mass to about 15% by mass, or from about 0.1% by mass to about 13% by mass, or from about 0.2% by mass to about 12% by mass, or from about 0.3% by mass to about 10% by mass, or from about 0.5% by mass to about 8% by mass, or from about 0.6% by mass to about 6% by mass, or from about 0.7% by mass to about 5% by mass, or from about 0.8% by mass to about 3% by mass, or from about 0.85% by mass to about 2% by mass, or from about 0.9% by mass to about 1.5% by mass, relative to a total mass of the RI-matched photo-curable composition.

In some embodiments the refractive index of the RI-matched additive ranges from about 1.200 to about 1.800. In other embodiments the refractive index of the RI-matched additive ranges from about 1.300 to about 1.700, while in other embodiments the refractive index of the RI-matched additive ranges from about 1.400 to about 1.600. In some embodiments it may be preferable to employ an RI-matched additive having a refractive index ranging from about 1.450 to about 1.550. In some embodiments the refractive index of a mineral additive may be modified in order to generate a RI-matched additive. For example, in some embodiments a mineral may be subjected to benefication in order to remove minerals having refractive indexes significantly different than the refractive index of the photo-curable resin.

In some embodiments the pre-polymer mixture includes at least one solvent. In some embodiments the pre-polymer mixture contains a mixture of two organic solvents, such that a ratio of the first organic solvent to the second organic solvent ranges from about 0.1:99.99 to about 99.9:0.1. This ratio may be determined based on the respective volumes of the first organic solvent and the second organic solvent (v/v), or the respective masses of the first organic solvent and the second organic solvent (wt/wt). In other embodiments the ratio of the first organic solvent to the second organic solvent ranges from about 1:99 to about 99:1, or from about 5:95 to about 95:5, or from about 10:90 to about 90:10, or from about 15:95 to about 95:15, or from about 20:80 to about 80:20, or from about 25:75 to about 75:25, or from about 30:70 to about 70:30, or from about 35:65 to about 65:35, or from about 40:60 to about 60:40, or from about 45:55 to about 55:45, or is about 50:50.

In some embodiments the pre-polymer mixture contains water, while in other embodiments the pre-polymer mixture contains at least one organic solvent. In some embodiments the pre-polymer mixture comprises at least one solvent selected from the group consisting of water, an ether-containing solvent, an alcohol-containing solvent, an amine-containing solvent, an acid-containing solvent, an ester-containing solvent, a ketone-containing solvent, an aromatic hydrocarbon-containing solvent, an aliphatic hydrocarbon-containing solvent, a polar protic solvent, a polar aprotic solvent, and mixtures thereof. Solvents of the pre-polymer mixture may also be compounds of mixed character, such as aliphatic-aromatic compounds, alcohol-ester compounds, alcohol-ether compounds, to name a few. Solvents of the pre-polymer mixture may also be halogenated compounds such as halogenated aromatic compounds and halogenated aliphatic compounds.

In some embodiments the pre-polymer mixture comprises at least one solvent selected from the group consisting of acetone, acetonitrile, anisole, benzene, benzonitrile, benzyl alcohol, 1,3-butanediol, 2-butanone, tert-butanol, 1-butanol, 2-butanol, 2-(2-butoxyethoxy)ethyl acetate, 2-butoxyethyl acetate, butyl acetate, tert-butyl aceto acetate, tert-butyl methyl ether, carbon disulfide, carbon tetrachloride, chlorobenzene, 1-chlorobutane, chloroform, cyclohexane, cyclopentane, cyclopentyl methyl ether, decane, dibutyl ether, 1,2-dichlorobenzene, 1,2-dichloroethane, dichloromethane, diethyl ether, diethylene glycol butyl ether, diethylene glycol diethyl ether, diethylene glycol dimethyl ether, diethylene glycol monoethyl ether, diethylene glycol monoethyl ether acetate, diisopropyl ether, N,N-diisopropylethylamine, 1,2-dimethoxyethane, dimethyl carbonate, dimethyl sulfoxide, N,N-dimethylacetamide, 1,4-dioxane, 1,3-dioxolane, dodecane, ethanol, 2-ethoxyethanol, ethyl 3-ethoxyproprionate, ethyl acetate, ethylbenzene, ethylene carbonate, ethylene glycol, ethylene glycol butyl ether, ethylene glycol diethyl ether, 2-ethylhexyl acetate, formamide, glycerol, heptane, 2-heptanone, hexadecane, hexane, hexanol, isopentyl acetate, isopropyl acetate, isopropyl alcohol, methanol, 2-methoxyethanol, 2-methoxyethyl acetate, 1-methoxy-2-propanol, methyl acetate, methyl formate, 2-methylbutane, isoamyl alcohol, methylcyclohexane, 5-methyl-2-hexanone, 4-methyl-2-pentanone, isobutyl alcohol, 1-methyl-2-pyrrolidinone, 2-methyltetrahydrofuran, nitrobenzene, nitromethane, nonane, octane, 1-octanol, pentane, 1-pentanol, 2-pentanone, 3-pentanone, petroleum ether, piperidine, 1-propanol, 2-propanol, 2-propoxyethanol, propyl acetate, propylene carbonate, pyridine, 1,1,2,2-tetrachloroethane, tetrachloroethylene, tetrahydrofuran, toluene, 1,2,4-trichlorobenzene, 2,2,4-trimethylpentane, water, m-xylene, o-xylene, p-xylene, and mixtures thereof.

In some embodiments the pre-polymer mixture may contain at least one addition (non-RI-matched) additive. Additional (non-RI-matched) additives may include the additives described above (including reinforcing additives and mineral pigments) that are not RI-matched to the photo-curable resin. In some embodiments the pre-polymer mixture may contain at least one non-RI-matched additive selected from a filler, a polymerization inhibitor, a UV stabilizer, an air-release agent, a sensitizer, a dye, a pigment, a cross-linking agent, and mixtures thereof. In some embodiments the pre-polymer mixture may contain at least one non-RI-matched secondary mineral selected from kaolin, a bentonite, a talc, a chloritic talc, a milled expanded perlite, and a diatomite.

In some embodiments the ratio of the refractive index of the RI-matched additive to the refractive index of the photo-curable resin ranges from about 0.8:1 to about 1.2:1. In other embodiments the ratio of the refractive index of the RI-matched additive to the refractive index of the photo-curable resin ranges from about 0.9:1 to about 1.1:1, or from about 0.95:1 to about 1.05:1, or from about 0.98:1 to about 1.02:1.

Some embodiments of the present disclosure relate to a composite material obtained by photopolymerizing the RI-matched photo-curable composition.

### Additive Manufacturing Process

Some embodiments of the present disclosure relate to an additive-manufacturing process including the steps of delivering the RI-matched photo-curable composition of claim A1 onto a working surface to obtain a pre-polymer deposit on the working surface, applying photons to the pre-polymer deposit to obtain a polymer in the form of a section plane of a component, and repeating the delivering and applying steps for successive section planes to fabricate the component.

In some embodiments shapes and contents of the section plane are defined at least in part by respective shapes and contents of the pre-polymer deposit. In other embodiments the contents of the section plane are defined at least in part by respective contents of the pre-polymer deposit, and the shapes of the section plane are defined at least in part by respective shapes of the pre-polymer deposit, or by dimensions and intensities of the photons, or by a combination thereof. Furthermore, the use of the RI-matched photo-curable composition enables the fabrication of objects having improved mechanical and optical properties compared to non-RI-matched photo-curable compositions, without jeopardizing the efficiency of the additive manufacturing process or the physical integrity of the object.

Some embodiments of the present disclosure relate to an additive-manufacturing process including the steps of delivering a plurality of the RI-matched photo-curable composition onto the working surface to obtain a multi-composition deposit on the working surface, and concurrently or sequentially applying a series of laser energies to the multi-composition deposit to obtain a plurality of polymers together forming the section plane of the component, in which the shapes and the contents of the section plane are defined at least in part by respective shapes and contents of the multi-component deposit, and repeating the delivering and applying steps for successive section planes to fabricate the component, wherein the series of laser energies includes a first laser energy of a first intensity applied to a first pre-polymer deposit, and a second laser energy of a second laser intensity applied to a second pre-polymer deposit.

Other embodiments of the present disclosure relate to an additive-manufacturing process include the steps of delivering a plurality of the RI-matched photo-curable composition onto the working surface to obtain a multi-composition deposit on the working surface, applying the photons to the multi-composition deposit to obtain a plurality of polymers together forming the section plane of the component, in which the shapes and the contents of the section plane are defined at least in part by respective shapes and contents of the multi-component deposit, and repeating the delivering and applying steps for successive section planes to fabricate the component, such that the multi-composition deposit includes a first photo-curable composition and a second photo-curable composition delivered to first and second areas on the working surface, said first and second areas optionally being in contact, and respective ratios of the refractive indexes of the additives to the refractive indexes of the photo-curable resins in the first and second photo-curable compositions are different, such that respective intensities of photons penetrating the first and second photo-curable compositions on the working surface are different.

In some embodiments the additive-manufacturing process is performed such that the RI-matched additive and the photo-curable resin are delivered to the working surface separately, and are then mixed on the working surface to form the pre-polymer deposit. In such embodiments the mixing may occur by agitation of the working surface using, for example, ultrasonic agitation of the working surface.

In some embodiments the photons are applied to spatially-localized regions of the working surface, such that dimensions of the section plane are defined at least in part by dimensions of the spatially-localized regions and by intensities of the photons. Use of the RI-matched photo-curable composition allows the thickness of the section plane to be increased relative to the thickness of a section plane formed from a non-RI-matched photo-curable composition, because RI matching reduces the opacity of the RI-matched photo-curable resin allowing greater penetration of the photons into the pre-polymer deposit. Reduced scattering of the photons in the RI-matched photo-curable composition also improves the efficiency of the additive manufacturing process by allowing the intensity of the photons to be reduced relative to the intensity of photons necessary to cure a non-RI-matched photo-curable composition. Reduced scattering of the photons in the RI-matched photo-curable composition also improves the efficiency of the additive manufacturing process by increasing the curing rate relative to the curing rate of a non-RI-matched photo-curable composition at a given photon intensity.

In some embodiments the photons are ultraviolet photons, while in other embodiments the photons may be selected from one or more photons having a wavelength ranging from about 1 picometer to about 1 millimeter. In some embodiments the photon is in the form of at least one radiation source having a wavelength ranging from about 10 nanometers to about 1,000 micrometers.

In some embodiments the photons are supplied by at least photon source selected a black light, a short-wave ultraviolet lamp, a gas-discharge lamp, an ultraviolet LED, an ultraviolet laser and a tunable vacuum ultraviolet source. In some embodiments the photons are supplied by a continuous wave laser source. In other embodiments the photons are supplied by a pulsed wave laser source.

In some embodiments the thickness of the section plane ranges from about 500 nm to about 1000 μm. In other embodiments the section plane ranges from about 1 μm to about 500 μm, or from about 20 μm to about 300 μm, or from about 50 μm to about 100 μm.

Method for Increasing Curing Rate of a Photo-Initiated Polymerization

Some embodiments of the present disclosure relate to a method for increasing the curing rate of a photo-initiated polymerization, including the steps of: (a) selecting a photo-curable resin corresponding to a desired polymer; (b) obtaining a refractive index of the photo-curable resin; (c) selecting an RI-matched additive such that a ratio of a refractive index of the additive to the refractive index of the photo-curable resin ranges from about 0.8:1 to about 1.2:1; and (d) performing an RI-matched photo-polymerization of a composition comprising the photo-curable resin and the RI-matched additive to obtain the desired polymer, wherein a curing rate of the RI-matched photo-polymerization is greater than a curing rate of a non-RI-matched photo-polymerization of the photo-curable resin performed in the absence of the RI-matched additive.

In some embodiments the refractive index of the photo-curable resin is obtained by measuring the refractive index of the photo-curable resin. In other embodiments the steps (a) and (b) comprise adjusting the contents of a pre-polymer mixture to obtain the photo-curable resin, such that a refractive index of the pre-polymer mixture is different than the refractive index of the photo-curable resin.

In some embodiments the refractive index of the photo-curable resin depends upon the proportions and refractive indexes of the components making up the pre-polymer mixture (i.e., initiator, monomer(s), macromer(s), solvent(s), additional additive(s)).

In some embodiments, a relatively high proportion of the pre-polymer mixture is composed of a monomer, a macromer, or a combination thereof, such that the refractive index of the pre-polymer mixture is determined in large measure based on the refractive indexes of the monomer and/or the macromer. In some embodiments the refractive index of the pre-polymer mixture can be readily adjusted by altering the identity and/or relative proportions of the monomer and/or macromer in the pre-polymer mixture. By example, if a mineral additive contained in a photo-curable composition has a refractive index of 1.500, then a pre-polymer mixture may be formulated by choosing the identify and/or relative proportions of a monomer and/or macromer such that the refractive index of the resulting pre-polymer mixture ranges from about 1.250 to about 1.750. In such an embodiment it can be said that the mineral additive is RI-matched to the pre-polymer mixture (photo-curable resin), because the ratio of the RI of the mineral additive (1.500) to the RI of the photo-curable resin (1.250-1.750) ranges from about 0.8:1 to about 1.2:1.

In some the refractive index of the photo-curable resin can be adjusted and modulated using a quantitative process based on the relative curing rate of the pre-polymer mixture versus the curing rate of the RI-matched photo-curable composition containing the additive. This quantitative process includes (i) formulating an initial pre-polymer mixture and measuring the refractive index of the initial pre-polymer mixture, (ii) measuring a curing rate of the initial pre-polymer mixture, (iii) preparing an initial photo-curable composition containing the initial pre-polymer mixture and an additive having a refractive index similar to the measured refractive index of the initial pre-polymer mixture, (iv) measuring the curing rate of the initial photo-curable composition, and comparing the curing rates of the initial pre-polymer mixture versus that of the initial photo-curable composition, (v) if the curing rates of the initial pre-polymer mixture and the initial photo-curable composition exceed an upper difference threshold, then altering the initial pre-polymer mixture by changing the identity and/or proportions of the monomer(s) and/or macromer(s) contained in the initial pre-polymer mixture to obtain a modified pre-polymer mixture, (vi) measuring a curing rate of the modified pre-polymer mixture, (vii) preparing a modified photo-curable composition containing the modified pre-polymer mixture and the same additive used in the initial pre-polymer mixture, (viii) measuring the curing rate of the modified photo-curable composition, and comparing the curing rates of the modified pre-polymer mixture versus that of the modified photo-curable composition, and (ix) repeating the steps (v)-(viii) if the curing rates of the modified pre-polymer mixture and the modified photo-curable composition exceed the upper difference threshold.

In some embodiments the refractive index of a mineral additive may be modified in order to generate a RI-matched additive. For example, in some embodiments a mineral may be subjected to benefication in order to remove minerals having refractive indexes significantly different than the refractive index of the photo-curable resin.

Method for Improving the Mechanical Properties of a Composite Material

Some embodiments of the present disclosure relate to a method for improving the mechanical properties of a composite material, including the steps of: (a) selecting a pre-polymer mixture capable of undergoing photo-polymerization to form a desired polymer; (b) selecting a reinforcing additive capable of improving at least one mechanical property of a solid material formed from the desired polymer and the reinforcing additive; (d) obtaining a refractive index of the reinforcing additive; (e) adjusting the contents of the pre-polymer mixture to obtain a photo-curable resin, such that a refractive index of the pre-polymer mixture is different from the refractive index of the photo-curable resin, and a ratio of the refractive index of the reinforcing additive to a refractive index of the photo-curable resin ranges from about 0.8:1 to about 1.2:1; and (f) performing a photo-polymerization of a composition comprising the photo-curable resin and the reinforcing additive to obtain a composite material, such that a mechanical strength of the composite material is greater than a mechanical strength of the solid material.

In some embodiments the refractive index of the photo-curable resin depends upon the proportions and refractive indexes of the components making up the pre-polymer mixture (i.e., initiator, monomer(s), macromer(s), solvent(s), additional additive(s)).

In some embodiments, a relatively high proportion of the pre-polymer mixture is composed of a monomer, a macromer, or a combination thereof, such that the refractive index of the pre-polymer mixture is determined in large measure based on the refractive indexes of the monomer and/or the macromer. In some embodiments the refractive index of the pre-polymer mixture can be readily adjusted by altering the identity and/or relative proportions of the monomer and/or macromer in the pre-polymer mixture. By example, if a mineral additive contained in a photo-curable composition has a refractive index of 1.500, then a pre-polymer mixture may be formulated by choosing the identify and/or relative proportions of a monomer and/or macromer such that the refractive index of the resulting pre-polymer mixture ranges from about 1.250 to about 1.750. In such an embodiment it can be said that the mineral additive is RI-matched to the pre-polymer mixture (photo-curable resin), because the ratio of the RI of the mineral additive (1.500) to the RI of the photo-curable resin (1.250-1.750) ranges from about 0.8:1 to about 1.2:1.

In some the refractive index of the photo-curable resin can be adjusted and modulated using a quantitative process based on the relative curing rate of the pre-polymer mixture versus the curing rate of the RI-matched photo-curable composition containing the additive. This quantitative process includes (i) formulating an initial pre-polymer mixture and measuring the refractive index of the initial pre-polymer mixture, (ii) measuring a curing rate of the initial pre-polymer mixture, (iii) preparing an initial photo-curable composition containing the initial pre-polymer mixture and an additive having a refractive index similar to the measured refractive index of the initial pre-polymer mixture, (iv) measuring the curing rate of the initial photo-curable composition, and comparing the curing rates of the initial pre-polymer mixture versus that of the initial photo-curable composition, (v) if the curing rates of the initial pre-polymer mixture and the initial photo-curable composition exceed an upper difference threshold, then altering the initial pre-polymer mixture by changing the identity and/or proportions of the monomer(s) and/or macromer(s) contained in the initial pre-polymer mixture to obtain a modified pre-polymer mixture, (vi) measuring a curing rate of the modified pre-polymer mixture, (vii) preparing a modified photo-curable composition containing the modified pre-polymer mixture and the same additive used in the initial pre-polymer mixture, (viii) measuring the curing rate of the modified photo-curable composition, and comparing the curing rates of the modified pre-polymer mixture versus that of the modified photo-curable composition, and (ix) repeating the steps (v)-(viii) if the curing rates of the modified pre-polymer mixture and the modified photo-curable composition exceed the upper difference threshold.

In some embodiments the refractive index of a mineral additive may be modified in order to generate a RI-matched additive. For example, in some embodiments a mineral may be subjected to benefication in order to remove minerals having refractive indexes significantly different than the refractive index of the photo-curable resin.

### EMBODIMENTS

Embodiment [1] of the present disclosure relates to an RI-matched photo-curable composition, comprising a photo-curable resin, and a refractive index-matched additive, wherein a ratio of a refractive index of the additive to a refractive index of the photo-curable resin ranges from about 0.8:1 to about 1.2:1.

Embodiment [2] of the present disclosure relates to the composition of Embodiment [1], wherein the additive is an organic or inorganic material.

Embodiment [3] of the present disclosure relates to the composition of Embodiments [1] and [2], wherein the additive is an organic particulate material or fibrous material.

Embodiment [4] of the present disclosure relates to the composition of Embodiments [1] to [3], wherein the additive is an inorganic mineral.

Embodiment [5] of the present disclosure relates to the composition of Embodiments [1] to [4], wherein the additive is at least one selected from the group consisting of a silica, an alumina, a gypsum, a talc, a mica, a montmorillonite mineral, a chalk, a diatomaceous earth, bauxite, limestone, sandstone, an aerogel, a xerogel, a microsphere, a porous ceramic sphere, gypsum dihydrate, calcium aluminate, magnesium carbonate, a ceramic material, a pozzolanic material, a zirconium compound, a xonotlite, a calcium silicate, a perlite, a vermiculite, a hydrated or unhydrated hydraulic cement particle, a pumice, a zeolite, a kaolin, calcium phosphate, barium sulfate, sodium carbonate, magnesium sulfate, aluminum sulfate, magnesium carbonate, barium carbonate, calcium oxide, magnesium oxide, calcium sulfate, barium sulfate, lithium fluoride, and calcium carbonate.

Embodiment [6] of the present disclosure relates to the composition of Embodiments [1] to [5], wherein the additive is at least one selected from the group consisting of a metal oxide, a metal silicate, a metal sulfate, a metal carbonate, an metal oxosulfate, a metal phosphate, a metal phosphonate, and mixtures thereof.

Embodiment [7] of the present disclosure relates to the composition of Embodiments [1] to [6], wherein the additive is a silicate or an alumino-silicate of an alkali or alkaline earth metal.

Embodiment [8] of the present disclosure relates to the composition of Embodiments [1] to [7], wherein the additive is an aluminosilicate.

Embodiment [9] of the present disclosure relates to the composition of Embodiment [8], wherein the aluminosilicate is perlite.

Embodiment [10] of the present disclosure relates to the composition of Embodiments [1] to [9], wherein the additive is a refractive index-matched mineral.

Embodiment [11] of the present disclosure relates to the composition of Embodiments [1] to [10], wherein the additive is a surface-modified mineral that is refractive index matched to the photo-curable resin.

Embodiment [12] of the present disclosure relates to the composition of Embodiment [11], wherein the surface-modified mineral is an engineered aluminosilicate formed by reacting an acrylate-functional silane with an aluminosilicate that is refractive index matched to the photo-curable resin.

Embodiment [13] of the present disclosure relates to the composition of Embodiments [11] to [12], wherein the surface-modified mineral is an engineered aluminosilicate formed by reacting (3-acryloxypropyl)trimethoxysilane with an aluminosilicate that is refractive index matched to the photo-curable resin.

Embodiment [14] of the present disclosure relates to the composition of Embodiments [1] to [13], wherein the additive has a median particle size (d50) of greater than or equal to about 0.5 μm.

Embodiment [15] of the present disclosure relates to the composition of Embodiments [1] to [14], wherein the additive has a median particles size (d50) ranging from about 1 μm to about 100 μm.

Embodiment [16] of the present disclosure relates to the composition of Embodiments [1] to [15], wherein the additive has a BET surface area of greater than or equal to about 3.0 m²/g.

Embodiment [17] of the present disclosure relates to the composition of Embodiments [1] to [16], wherein the photo-curable resin comprises a pre-polymer mixture comprising: an initiator; a monomer, a macromer, or a mixture thereof; and optionally at least one additional additive.

Embodiment [18] of the present disclosure relates to the composition of Embodiment [17], wherein the pre-polymer mixture comprises at least one monomer selected from the group consisting of an alkyl (meth) acrylate, a hydroxyl-containing (meth)acrylate, an amide-containing (meth)acrylate, an amino-containing (meth)acrylate, an epoxy-containing (meth)acrylate, a carboxylic acid-containing (meth)acrylate, a salt of a carboxylic acid-containing (meth)acrylate and mixtures thereof.

Embodiment [19] of the present disclosure relates to the composition of Embodiments [17] to [18], wherein the pre-polymer mixture comprises at least one alkyl (meth)acrylate containing an alkyl group selected from the group consisting of a methyl group, an ethyl group, an n-propyl group, an isopropyl group, an n-butyl group, an isobutyl group, a t-butyl group, a 2-ethylhexyl group, a lauryl group, a stearyl group, a cyclohexyl group, a phenyl group, a benzyl group and a phenylethyl group.

Embodiment [20] of the present disclosure relates to the composition of Embodiments [17] to [19], wherein the pre-polymer mixture comprises at least one monomer selected from the group consisting of 2-hydroxyethyl acrylate, 2-hydroxyethyl methacrylate, 2-hydroxypropyl acrylate, and 2-hydroxypropyl methacrylate.

Embodiment [21] of the present disclosure relates to the composition of Embodiments [17] to [20], wherein the pre-polymer mixture comprises at least one monomer selected from the group consisting of acrylamide, methacrylamide, N-methyl acrylamide, N-methyl methacrylamide, N-methylol acrylamide, N-methylol methacrylamide, N,N-dimethylol acrylamide, N-methoxymethyl acrylamide, N-methoxymethylmethacrylamide, N-phenyl acrylamide, N,N-diethylamino ethyl acrylate and N,N-diethylamino ethyl methacrylate.

Embodiment [22] of the present disclosure relates to the composition of Embodiments [17] to [21], wherein the pre-polymer mixture comprises a macromer comprising a urethane (meth)acrylate compound.

Embodiment [23] of the present disclosure relates to the composition of Embodiment [22], wherein the urethane (meth)acrylate compound is obtained by reacting a hydroxy-terminated polyurethane with a (meth)acrylic acid or derivative thereof.

Embodiment [24] of the present disclosure relates to the composition of Embodiments [22] to [23], wherein the urethane (meth)acrylate compound is obtained by reacting an isocyanate-terminated pre-polymer with a hydroxyalkyl (meth)acrylate.

Embodiment [25] of the present disclosure relates to the composition of Embodiments [17] to [24], wherein the pre-polymer mixture comprises at least one photoinitiator selected from the group consisting of benzophenone, methyl benzophenone, a xanthone, an acylphosphine oxide, a benzoin compound and a benzoin alkyl ether compound.

Embodiment [26] of the present disclosure relates to the composition of Embodiments [17] to [25], wherein the pre-polymer mixture comprises at least one additional additive selected from the group consisting of a filler, a polymerization inhibitor, a UV stabilizer, an air-release agent, a sensitizer, a dye, a pigment, a cross-linking agent, and mixtures thereof.

Embodiment [27] of the present disclosure relates to the composition of Embodiments [1] to [26], wherein the ratio of the refractive index of the additive to the refractive index of the photo-curable resin ranges from about 0.9:1 to about 1.1:1.

Embodiment [28] of the present disclosure relates to the composition of Embodiments [1] to [27], wherein the ratio of the refractive index of the additive to the refractive index of the photo-curable resin ranges from about 0.95:1 to about 1.05:1.

Embodiment [29] of the present disclosure relates to the composition of Embodiments [1] to [28], wherein the refractive index of the additive ranges from about 1.2 to about 1.8.

Embodiment [30] of the present disclosure relates to the composition of Embodiments [1] to [29], wherein the refractive index of the photo-curable resin ranges from about 1.2 to about 1.8.

Embodiment [31] of the present disclosure relates to the composition of Embodiments [1] to [30], wherein the refractive index-matched additive is a reinforcing additive or a mineral pigment.

Embodiment [32] of the present disclosure relates to the composition of Embodiments [1] to [31], wherein the refractive index-matched additive is a reinforcing additive.

Embodiment [33] of the present disclosure relates to the composition of Embodiments [1] to [32], wherein the refractive index-matched additive is a mineral pigment.

Embodiment [34] of the present disclosure relates to an article obtained by polymerizing the composition of Embodiments [1] to [33].

Embodiment [35] of the present disclosure relates to an additive-manufacturing process, comprising delivering the refractive index-matched photo-curable composition of claim A1 onto a working surface to obtain a pre-polymer deposit on the working surface, and applying photons to the pre-polymer deposit to obtain a polymer in the form of a section plane of a component.

Embodiment [36] of the present disclosure relates to process of Embodiment [35], wherein shapes and contents of the section plane are defined at least in part by respective shapes and contents of the pre-polymer deposit.

Embodiment [37] of the present disclosure relates to the process of Embodiments [35] to [36], wherein contents of the section plane are defined at least in part by respective contents of the pre-polymer deposit, and shapes of the section plane are defined at least in part by respective shapes of the pre-polymer deposit, or by dimensions and intensities of the photons, or by a combination thereof.

Embodiment [38] of the present disclosure relates to the process of Embodiments [35] to [37], further comprising repeating the delivering and applying steps for successive section planes to fabricate the component.

Embodiment [39] of the present disclosure relates to the process of Embodiments [35] to [38], comprising: delivering a plurality of the refractive index-matched photo-curable composition onto the working surface to obtain a multi-composition deposit on the working surface; and concurrently or sequentially applying a series of laser energies to the multi-composition deposit to obtain a plurality of polymers together forming the section plane of the component, in which the shapes and the contents of the section plane are defined at least in part by respective shapes and contents of the multi-component deposit, wherein the series of laser energies includes a first laser energy of a first intensity applied to a first pre-polymer deposit, and a second laser energy of a second laser intensity applied to a second pre-polymer deposit.

Embodiment [40] of the present disclosure relates to the process of Embodiment [39], further comprising repeating the delivering and applying steps for successive section planes to fabricate the component.

Embodiment [41] of the present disclosure relates to the process of Embodiments [35] to [40], comprising: delivering a plurality of the refractive index-matched photo-curable composition onto the working surface to obtain a multi-composition deposit on the working surface; and applying the photons to the multi-composition deposit to obtain a plurality of polymers together forming the section plane of the component, in which the shapes and the contents of the section plane are defined at least in part by respective shapes and contents of the multi-component deposit, wherein: the multi-composition deposit includes a first photo-curable composition and a second photo-curable composition delivered to first and second areas on the working surface, said first and second areas optionally being in contact; and respective ratios of the refractive indexes of the additives to the refractive indexes of the photo-curable resins in the first and second photo-curable compositions are different, such that respective intensities of photons penetrating the first and second photo-curable compositions on the working surface are different.

Embodiment [42] of the present disclosure relates to the process of Embodiment [41], further comprising repeating the delivering and applying steps for successive section planes to fabricate the component.

Embodiment [43] of the present disclosure relates to the process of Embodiments [35] to [42], wherein the additive and the photo-curable resin are delivered to the working surface separately, and then mixed on the working surface to form the pre-polymer deposit.

Embodiment [44] of the present disclosure relates to the process of Embodiment [43], wherein the mixing occurs by agitation of the working surface.

Embodiment [45] of the present disclosure relates to the process of Embodiments [43] to [44], wherein the mixing occurs by ultrasonic agitation of the working surface.

Embodiment [46] of the present disclosure relates to the process of Embodiments [35] to [45], wherein the photons are applied to spatially-localized regions of the working surface, such that dimensions of the section plane are defined at least in part by dimensions of the spatially-localized regions and by intensities of the photons.

Embodiment [47] of the present disclosure relates to the process of Embodiments [35] to [46], wherein the photons are ultraviolet photons.

Embodiment [48] of the present disclosure relates to the process of Embodiments [35] to [47], wherein the photons are supplied by at least photon source selected from the group consisting of a black light, a short-wave ultraviolet lamp, a gas-discharge lamp, an ultraviolet LED, an ultraviolet laser and a tunable vacuum ultraviolet source.

Embodiment [49] of the present disclosure relates to the process of Embodiments [35] to [48], wherein the photons are supplied by an ultraviolet laser source.

Embodiment [50] of the present disclosure relates to the process of Embodiments [35] to [49], wherein the photons are supplied by a continuous wave laser source.

Embodiment [51] of the present disclosure relates to the process of Embodiments [35] to [50], wherein the photons are supplied by a pulsed wave laser source.

Embodiment [52] of the present disclosure relates to the process of Embodiments [35] to [51], wherein the additive is an organic or inorganic material.

Embodiment [53] of the present disclosure relates to the process of Embodiments [35] to [52], wherein the additive is an organic particulate material or fibrous material.

Embodiment [54] of the present disclosure relates to the process of Embodiments [35] to [53], wherein the additive is an inorganic mineral.

Embodiment [55] of the present disclosure relates to the process of Embodiments [35] to [54], wherein the additive is at least one selected from the group consisting of a silica, an alumina, a gypsum, a talc, a mica, a montmorillonite mineral, a chalk, a diatomaceous earth, bauxite, limestone, sandstone, an aerogel, a xerogel, a microsphere, a porous ceramic sphere, gypsum dihydrate, calcium aluminate, magnesium carbonate, a ceramic material, a pozzolanic material, a zirconium compound, a xonotlite, a calcium silicate, a perlite, a vermiculite, a hydrated or unhydrated hydraulic cement particle, a pumice, a zeolite, a kaolin, calcium phosphate, barium sulfate, sodium carbonate, magnesium sulfate, aluminum sulfate, magnesium carbonate, barium carbonate, calcium oxide, magnesium oxide, calcium sulfate, barium sulfate, lithium fluoride, and calcium carbonate.

Embodiment [56] of the present disclosure relates to the process of Embodiments [35] to [55], wherein the additive is at least one selected from the group consisting of a metal oxide, a metal silicate, a metal sulfate, a metal carbonate, an metal oxosulfate, a metal phosphate, a metal phosphonate, and mixtures thereof.

Embodiment [57] of the present disclosure relates to the process of Embodiments [35] to [56], wherein the additive is a silicate or an alumino-silicate of an alkali or alkaline earth metal.

Embodiment [58] of the present disclosure relates to the process of Embodiments [35] to [57], wherein the additive is an aluminosilicate.

Embodiment [59] of the present disclosure relates to the process of Embodiment [58], wherein the aluminosilicate is perlite.

Embodiment [60] of the present disclosure relates to the process of Embodiments [35] to [59], wherein the additive is a refractive index-matched mineral.

Embodiment [61] of the present disclosure relates to the process of Embodiments [35] to [60], wherein the additive is a surface-modified mineral that is refractive index matched to the photo-curable resin.

Embodiment [62] of the present disclosure relates to the process of Embodiment [61], wherein the surface-modified mineral is an engineered aluminosilicate formed by reacting an acrylate-functional silane with an aluminosilicate that is refractive index matched to the photo-curable resin.

Embodiment [63] of the present disclosure relates to the process of Embodiments [61] to [62], wherein the surface-modified mineral is an engineered aluminosilicate formed by reacting (3-acryloxypropyl) trimethoxysilane with an aluminosilicate that is refractive index matched to the photo-curable resin.

Embodiment [64] of the present disclosure relates to the process of Embodiments [35] to [63], wherein the additive has a median particle size (d50) of greater than or equal to about 0.5 μm.

Embodiment [65] of the present disclosure relates to the process of Embodiments [35] to [64], wherein the additive has a median particles size (d50) ranging from about 1 μm to about 100 μm.

Embodiment [66] of the present disclosure relates to the process of Embodiments [35] to [65], wherein the additive has a BET surface area of greater than or equal to about 3.0 m²/g.

Embodiment [67] of the present disclosure relates to the process of Embodiments [35] to [66], wherein the photo-curable resin comprises a pre-polymer mixture comprising: an initiator; a monomer, a macromer, or a mixture thereof; and optionally at least one additional additive.

Embodiment [68] of the present disclosure relates to the process of Embodiment [67], wherein the pre-polymer mixture comprises at least one monomer selected from the group consisting of an alkyl (meth) acrylate, a hydroxyl-containing (meth)acrylate, an amide-containing (meth)acrylate, an amino-containing (meth)acrylate, an epoxy-containing (meth)acrylate, a carboxylic acid-containing (meth)acrylate, a salt of a carboxylic acid-containing (meth)acrylate and mixtures thereof.

Embodiment [69] of the present disclosure relates to the process of Embodiments [67] to [68], wherein the pre-polymer mixture comprises at least one alkyl (meth)acrylate containing an alkyl group selected from the group consisting of a methyl group, an ethyl group, an n-propyl group, an isopropyl group, an n-butyl group, an isobutyl group, a t-butyl group, a 2-ethylhexyl group, a lauryl group, a stearyl group, a cyclohexyl group, a phenyl group, a benzyl group and a phenylethyl group.

Embodiment [70] of the present disclosure relates to the process of Embodiments [67] to [69], wherein the pre-polymer mixture comprises at least one monomer selected from the group consisting of 2-hydroxyethyl acrylate, 2-hydroxyethyl methacrylate, 2-hydroxypropyl acrylate, and 2-hydroxypropyl methacrylate.

Embodiment [71] of the present disclosure relates to the process of Embodiments [67] to [70], wherein the pre-polymer mixture comprises at least one monomer selected from the group consisting of acrylamide, methacrylamide, N-methyl acrylamide, N-methyl methacrylamide, N-methylol acrylamide, N-methylol methacrylamide, N,N-dimethylol acrylamide, N-methoxymethyl acrylamide, N-methoxymethylmethacrylamide, N-phenyl acrylamide, N,N-diethylamino ethyl acrylate and N,N-diethylamino ethyl methacrylate.

Embodiment [72] of the present disclosure relates to the process of Embodiments [67] to [71], wherein the pre-polymer mixture comprises a macromer comprising a urethane (meth)acrylate compound.

Embodiment [73] of the present disclosure relates to the process of Embodiment [72] B38, wherein the urethane (meth)acrylate compound is obtained by reacting a hydroxy-terminated polyurethane with a (meth)acrylic acid or derivative thereof.

Embodiment [74] of the present disclosure relates to the process of Embodiments [72] to [73], wherein the urethane (meth)acrylate compound is obtained by reacting an isocyanate-terminated pre-polymer with a hydroxyalkyl (meth)acrylate.

Embodiment [75] of the present disclosure relates to the process of Embodiments [67] to [74], wherein the pre-polymer mixture comprises at least one photoinitiator selected from the group consisting of benzophenone, methyl benzophenone, a xanthone, an acylphosphine oxide, a benzoin compound and a benzoin alkyl ether compound.

Embodiment [76] of the present disclosure relates to the process of Embodiments [67] to [75], wherein the pre-polymer mixture comprises at least one additional additive selected from the group consisting of a filler, a polymerization inhibitor, a UV stabilizer, an air-release agent, a sensitizer, a dye, a pigment, a cross-linking agent, and mixtures thereof.

Embodiment [77] of the present disclosure relates to the process of Embodiments [1] to [76], wherein the ratio of the refractive index of the additive to the refractive index of the photo-curable resin ranges from about 0.9:1 to about 1.1:1.

Embodiment [78] of the present disclosure relates to the process of Embodiments [35] to [77], wherein the ratio of the refractive index of the additive to the refractive index of the photo-curable resin ranges from about 0.95:1 to about 1.05:1.

Embodiment [79] of the present disclosure relates to the process of Embodiments [35] to [78], wherein the refractive index of the additive ranges from about 1.2 to about 1.8.

Embodiment [80] of the present disclosure relates to the process of Embodiments [35] to [79], wherein the refractive index of the photo-curable resin ranges from about 1.2 to about 1.8.

Embodiment [81] of the present disclosure relates to the process of Embodiments [35] to [80], wherein the refractive index-matched additive is a reinforcing additive or a mineral pigment.

Embodiment [82] of the present disclosure relates to the process of Embodiments [35] to [81], wherein the refractive index-matched additive is a reinforcing additive.

Embodiment [83] of the present disclosure relates to the process of Embodiments [35] to [82], wherein the refractive index-matched additive is a mineral pigment.

Embodiment [84] of the present disclosure relates to an article obtained by the process of Embodiments [35] to [83].

Embodiment [85] of the present disclosure relates to a method for increasing the curing rate of a photo-initiated polymerization, the method comprising: (a) selecting a photo-curable resin corresponding to a desired polymer; (b) obtaining a refractive index of the photo-curable resin; (c) selecting a refractive index-matched additive such that a ratio of a refractive index of the additive to the refractive index of the photo-curable resin ranges from about 0.8:1 to about 1.2:1; and (d) performing a refractive index-matched photo-polymerization of a composition comprising the photo-curable resin and the refractive index-matched additive to obtain the desired polymer, wherein a curing rate of the refractive index-matched photo-polymerization is greater than a curing rate of a non-index-matched photo-polymerization of the photo-curable resin performed in the absence of the refractive index-matched additive.

Embodiment [86] of the present disclosure relates to the method of Embodiment [85], wherein the refractive index of the photo-curable resin is obtained by measuring the refractive index of the photo-curable resin.

Embodiment [87] of the present disclosure relates to the method of Embodiment [85] to [86], wherein the steps (a) and (b) comprise adjusting the contents of a pre-polymer mixture to obtain the photo-curable resin, wherein a refractive index of the pre-polymer mixture is different than the refractive index of the photo-curable resin.

Embodiment [88] of the present disclosure relates to the method of Embodiment [85] to [87], wherein the additive is an organic or inorganic material.

Embodiment [89] of the present disclosure relates to the method of Embodiment [85] to [88], wherein the additive is an organic particulate material or fibrous material.

Embodiment [90] of the present disclosure relates to the method of Embodiment [85] to [89], wherein the additive is an inorganic mineral.

Embodiment [91] of the present disclosure relates to the method of Embodiment [85] to [90], wherein the additive is at least one selected from the group consisting of a silica, an alumina, a gypsum, a talc, a mica, a montmorillonite mineral, a chalk, a diatomaceous earth, bauxite, limestone, sandstone, an aerogel, a xerogel, a microsphere, a porous ceramic sphere, gypsum dihydrate, calcium aluminate, magnesium carbonate, a ceramic material, a pozzolanic material, a zirconium compound, a xonotlite, a calcium silicate, a perlite, a vermiculite, a hydrated or unhydrated hydraulic cement particle, a pumice, a zeolite, a kaolin, calcium phosphate, barium sulfate, sodium carbonate, magnesium sulfate, aluminum sulfate, magnesium carbonate, barium carbonate, calcium oxide, magnesium oxide, calcium sulfate, barium sulfate, lithium fluoride, and calcium carbonate.

Embodiment [92] of the present disclosure relates to the method of Embodiment [85] to [91], wherein the additive is at least one selected from the group consisting of a metal oxide, a metal silicate, a metal sulfate, a metal carbonate, an metal oxosulfate, a metal phosphate, a metal phosphonate, and mixtures thereof.

Embodiment [93] of the present disclosure relates to the method of Embodiment [85] to [92], wherein the additive is a silicate or an aluminosilicate of an alkali or alkaline earth metal.

Embodiment [94] of the present disclosure relates to the method of Embodiment [85] to [93], wherein the additive is an aluminosilicate.

Embodiment [95] of the present disclosure relates to the method of Embodiment [94], wherein the aluminosilicate is perlite.

Embodiment [96] of the present disclosure relates to the method of Embodiment [85] to [95], wherein the additive is a refractive index-matched mineral.

Embodiment [97] of the present disclosure relates to the method of Embodiment [85] to [96], wherein the additive is a surface-modified mineral that is refractive index matched to the photo-curable resin.

Embodiment [98] of the present disclosure relates to the method of Embodiment [97], wherein the surface-modified mineral is an engineered aluminosilicate formed by reacting an acrylate-functional silane with an aluminosilicate that is refractive index matched to the photo-curable resin.

Embodiment [99] of the present disclosure relates to the method of Embodiment [97] to [98], wherein the surface-modified mineral is an engineered aluminosilicate formed by reacting (3-acryloxypropyl) trimethoxysilane with an aluminosilicate that is refractive index matched to the photo-curable resin.

Embodiment [100] of the present disclosure relates to the method of Embodiment [85] to [99], wherein the additive has a median particle size (d50) of greater than or equal to about 0.5 μm.

Embodiment [101] of the present disclosure relates to the method of Embodiment [85] to [100], wherein the additive has a median particles size (d50) ranging from about 1 μm to about 100 μm.

Embodiment [102] of the present disclosure relates to the method of Embodiment [85] to [101], wherein the additive has a BET surface area of greater than or equal to about 3.0 m²/g.

Embodiment [103] of the present disclosure relates to the method of Embodiment [85] to [102], wherein the photo-curable resin comprises a pre-polymer mixture comprising: an initiator; a monomer, a macromer, or a mixture thereof; and optionally at least one additional additive.

Embodiment [104] of the present disclosure relates to the method of Embodiment [103], wherein the pre-polymer mixture comprises at least one monomer selected from the group consisting of an alkyl (meth) acrylate, a hydroxyl-containing (meth)acrylate, an amide-containing (meth)acrylate, an amino-containing (meth)acrylate, an epoxy-containing (meth)acrylate, a carboxylic acid-containing (meth)acrylate, a salt of a carboxylic acid-containing (meth)acrylate and mixtures thereof.

Embodiment [105] of the present disclosure relates to the method of Embodiment [103] to [104], wherein the pre-polymer mixture comprises at least one alkyl (meth)acrylate containing an alkyl group selected from the group consisting of a methyl group, an ethyl group, an n-propyl group, an isopropyl group, an n-butyl group, an isobutyl group, a t-butyl group, a 2-ethylhexyl group, a lauryl group, a stearyl group, a cyclohexyl group, a phenyl group, a benzyl group and a phenylethyl group.

Embodiment [106] of the present disclosure relates to the method of Embodiment [103] to [105], wherein the pre-polymer mixture comprises at least one monomer selected from the group consisting of 2-hydroxyethyl acrylate, 2-hydroxyethyl methacrylate, 2-hydroxypropyl acrylate, and 2-hydroxypropyl methacrylate.

Embodiment [107] of the present disclosure relates to the method of Embodiment [103] to [106], wherein the pre-polymer mixture comprises at least one monomer selected from the group consisting of acrylamide, methacrylamide, N-methyl acrylamide, N-methyl methacrylamide, N-methylol acrylamide, N-methylol methacrylamide, N,N-dimethylol acrylamide, N-methoxymethyl acrylamide, N-methoxymethylmethacrylamide, N-phenyl acrylamide, N,N-diethylamino ethyl acrylate and N,N-diethylamino ethyl methacrylate.

Embodiment [108] of the present disclosure relates to the method of Embodiment [103] to [107], wherein the pre-polymer mixture comprises a macromer comprising a urethane (meth)acrylate compound.

Embodiment [109] of the present disclosure relates to the method of Embodiment [108], wherein the urethane (meth)acrylate compound is obtained by reacting a hydroxy-terminated polyurethane with a (meth)acrylic acid or derivative thereof.

Embodiment [110] of the present disclosure relates to the method of Embodiment [108] to [109], wherein the urethane (meth)acrylate compound is obtained by reacting an isocyanate-terminated pre-polymer with a hydroxyalkyl (meth)acrylate.

Embodiment [111] of the present disclosure relates to the method of Embodiment [103] to [110], wherein the pre-polymer mixture comprises at least one photoinitiator selected from the group consisting of benzophenone, methyl benzophenone, a xanthone, an acylphosphine oxide, a benzoin compound and a benzoin alkyl ether compound.

Embodiment [112] of the present disclosure relates to the method of Embodiment [103] to [111], wherein the pre-polymer mixture comprises at least one additional additive selected from the group consisting of a filler, a polymerization inhibitor, a UV stabilizer, an air-release agent, a sensitizer, a dye, a pigment, a cross-linking agent, and mixtures thereof.

Embodiment [113] of the present disclosure relates to the method of Embodiment [85] to [112], wherein the ratio of the refractive index of the additive to the refractive index of the photo-curable resin ranges from about 0.9:1 to about 1.1:1.

Embodiment [114] of the present disclosure relates to the method of Embodiment [85] to [113], wherein the ratio of the refractive index of the additive to the refractive index of the photo-curable resin ranges from about 0.95:1 to about 1.05:1.

Embodiment [115] of the present disclosure relates to the method of Embodiment [85] to [114], wherein the refractive index of the additive ranges from about 1.2 to about 1.8.

Embodiment [116] of the present disclosure relates to the method of Embodiment [85] to [115], wherein the refractive index of the photo-curable resin ranges from about 1.2 to about 1.8.

Embodiment [117] of the present disclosure relates to the method of Embodiment [85] to [116], wherein the refractive index-matched additive is a reinforcing additive or a mineral pigment.

Embodiment [118] of the present disclosure relates to the method of Embodiment [85] to [117], wherein the refractive index-matched additive is a reinforcing additive.

Embodiment [119] of the present disclosure relates to the method of Embodiment [85] to [118], wherein the refractive index-matched additive is a mineral pigment.

Embodiment [120] of the present disclosure relates to an article obtained by the method of Embodiments [85] to [119].

Embodiment [121] of the present disclosure relates to a method for improving the mechanical properties of a composite material, the method comprising: (a) selecting a pre-polymer mixture capable of undergoing photo-polymerization to form a desired polymer; (b) selecting a reinforcing additive capable of improving at least one mechanical property of a solid material formed from the desired polymer and the reinforcing additive; (d) obtaining a refractive index of the reinforcing additive; (e) adjusting the contents of the pre-polymer mixture to obtain a photo-curable resin, such that a ratio of the refractive index of the reinforcing additive to a refractive index of the photo-curable resin ranges from about 0.8:1 to about 1.2:1; and (f) performing a photo polymerization of a composition comprising the photo-curable resin and the reinforcing additive to obtain a composite material, wherein: a refractive index of the pre-polymer mixture is different from the refractive index of the photo-curable resin; and a mechanical strength of the composite material is greater than a mechanical strength of the solid material.

Embodiment [122] of the present disclosure relates to the process of Embodiment [121], wherein the reinforcing additive is an organic or inorganic material.

Embodiment [123] of the present disclosure relates to the process of Embodiments [121] to [122], wherein the reinforcing additive is an organic particulate material or fibrous material.

Embodiment [124] of the present disclosure relates to the process of Embodiments [121] to [123], wherein the reinforcing additive is an inorganic mineral.

Embodiment [125] of the present disclosure relates to the process of Embodiments [121] to [124], wherein the reinforcing additive is at least one selected from the group consisting of a silica, an alumina, a gypsum, a talc, a mica, a montmorillonite mineral, a chalk, a diatomaceous earth, bauxite, limestone, sandstone, an aerogel, a xerogel, a microsphere, a porous ceramic sphere, gypsum dihydrate, calcium aluminate, magnesium carbonate, a ceramic material, a pozzolanic material, a zirconium compound, a xonotlite, a calcium silicate, a perlite, a vermiculite, a hydrated or unhydrated hydraulic cement particle, a pumice, a zeolite, a kaolin, calcium phosphate, barium sulfate, sodium carbonate, magnesium sulfate, aluminum sulfate, magnesium carbonate, barium carbonate, calcium oxide, magnesium oxide, calcium sulfate, barium sulfate, lithium fluoride, and calcium carbonate.

Embodiment [126] of the present disclosure relates to the process of Embodiments [121] to [125], wherein the reinforcing additive is at least one selected from the group consisting of a metal oxide, a metal silicate, a metal sulfate, a metal carbonate, an metal oxosulfate, a metal phosphate, a metal phosphonate, and mixtures thereof.

Embodiment [127] of the present disclosure relates to the process of Embodiments [121] to [126], wherein the reinforcing additive is a silicate or an alumino-silicate of an alkali or alkaline earth metal.

Embodiment [128] of the present disclosure relates to the process of Embodiments [121] to [127], wherein the reinforcing additive is an aluminosilicate.

Embodiment [129] of the present disclosure relates to the process of Embodiments [123], wherein the aluminosilicate is perlite.

Embodiment [130] of the present disclosure relates to the process of Embodiments [121] to [129], wherein the reinforcing additive is a refractive index-matched mineral.

Embodiment [131] of the present disclosure relates to the process of Embodiments [121] to [130], wherein the reinforcing additive is a surface-modified mineral that is refractive index matched to the photo-curable resin.

Embodiment [132] of the present disclosure relates to the process of Embodiments [131], wherein the surface-modified mineral is an engineered aluminosilicate formed by reacting an acrylate-functional silane with an aluminosilicate that is refractive index matched to the photo-curable resin.

Embodiment [133] of the present disclosure relates to the process of Embodiments [131] to [132], wherein the surface-modified mineral is an engineered aluminosilicate formed by reacting (3-acryloxypropyl)trimethoxysilane with an aluminosilicate that is refractive index matched to the photo-curable resin.

Embodiment [134] of the present disclosure relates to the process of Embodiments [121] to [133], wherein the reinforcing additive has a median particle size (d50) of greater than or equal to about 0.5 μm.

Embodiment [135] of the present disclosure relates to the process of Embodiments [121] to [134], wherein the reinforcing additive has a median particles size (d50) ranging from about 1 μm to about 100 μm.

Embodiment [136] of the present disclosure relates to the process of Embodiments [121] to [135], wherein the reinforcing additive has a BET surface area of greater than or equal to about 3.0 m²/g.

Embodiment [137] of the present disclosure relates to the process of Embodiments [121] to [136], wherein the photo-curable resin comprises a pre-polymer mixture comprising: an initiator; a monomer, a macromer, or a mixture thereof; and optionally at least one additional additive.

Embodiment [138] of the present disclosure relates to the process of Embodiments [137], wherein the pre-polymer mixture comprises at least one monomer selected from the group consisting of an alkyl (meth) acrylate, a hydroxyl-containing (meth)acrylate, an amide-containing (meth)acrylate, an amino-containing (meth)acrylate, an epoxy-containing (meth)acrylate, a carboxylic acid-containing (meth)acrylate, a salt of a carboxylic acid-containing (meth)acrylate and mixtures thereof.

Embodiment [139] of the present disclosure relates to the process of Embodiments [137] to [138], wherein the pre-polymer mixture comprises at least one alkyl (meth)acrylate containing an alkyl group selected from the group consisting of a methyl group, an ethyl group, an n-propyl group, an isopropyl group, an n-butyl group, an isobutyl group, a t-butyl group, a 2-ethylhexyl group, a lauryl group, a stearyl group, a cyclohexyl group, a phenyl group, a benzyl group and a phenylethyl group.

Embodiment [140] of the present disclosure relates to the process of Embodiments [137] to [139], wherein the pre-polymer mixture comprises at least one monomer selected from the group consisting of 2-hydroxyethyl acrylate, 2-hydroxyethyl methacrylate, 2-hydroxypropyl acrylate, and 2-hydroxypropyl methacrylate.

Embodiment [141] of the present disclosure relates to the process of Embodiments [137] to [140], wherein the pre-polymer mixture comprises at least one monomer selected from the group consisting of acrylamide, methacrylamide, N-methyl acrylamide, N-methyl methacrylamide, N-methylol acrylamide, N-methylol methacrylamide, N,N-dimethylol acrylamide, N-methoxymethyl acrylamide, N-methoxymethylmethacrylamide, N-phenyl acrylamide, N,N-diethylamino ethyl acrylate and N,N-diethylamino ethyl methacrylate.

Embodiment [142] of the present disclosure relates to the process of Embodiments [137] to [141], wherein the pre-polymer mixture comprises a macromer comprising a urethane (meth)acrylate compound.

Embodiment [143] of the present disclosure relates to the process of Embodiments [121] to [142], wherein the urethane (meth)acrylate compound is obtained by reacting a hydroxy-terminated polyurethane with a (meth)acrylic acid or derivative thereof.

Embodiment [144] of the present disclosure relates to the process of Embodiments [142] to [143], wherein the urethane (meth)acrylate compound is obtained by reacting an isocyanate-terminated pre-polymer with a hydroxyalkyl (meth)acrylate.

Embodiment [145] of the present disclosure relates to the process of Embodiments [137] to [144], wherein the pre-polymer mixture comprises at least one photoinitiator selected from the group consisting of benzophenone, methyl benzophenone, a xanthone, an acylphosphine oxide, a benzoin compound and a benzoin alkyl ether compound.

Embodiment [146] of the present disclosure relates to the process of Embodiments [137] to [145], wherein the pre-polymer mixture comprises at least one additional additive selected from the group consisting of a filler, a polymerization inhibitor, a UV stabilizer, an air-release agent, a sensitizer, a dye, a pigment, a cross-linking agent, and mixtures thereof.

Embodiment [147] of the present disclosure relates to the process of Embodiments [121] to [146], wherein the ratio of the refractive index of the reinforcing additive to the refractive index of the photo-curable resin ranges from about 0.9:1 to about 1.1:1.

Embodiment [148] of the present disclosure relates to the process of Embodiments [121] to [147], wherein the ratio of the refractive index of the reinforcing additive to the refractive index of the photo-curable resin ranges from about 0.95:1 to about 1.05:1.

Embodiment [149] of the present disclosure relates to the process of Embodiments [121] to [148], wherein the refractive index of the reinforcing additive ranges from about 1.2 to about 1.8.

Embodiment [150] of the present disclosure relates to the process of Embodiments [121] to [149], wherein the refractive index of the photo-curable resin ranges from about 1.2 to about 1.8.

### EXAMPLES

The following examples are provided for illustration purposes only and in no way limit the scope of the present disclosure. Embodiments of the present disclosure employ the use of different or additional components such as other RI-matched reinforcing additives, other photo-curable resins, other radiation sources, as well as additional components, additives and processing steps.

### Study Overview

In the examples illustrated below, it was demonstrated that the presence of an RI-matched mineral reinforcing agent in a photo-curable resin composition does not significantly increase the haze of the photo-curable resin composition or lead to an opaque photo-curable composition. Comparative studies also illustrate that the curing rates of a photo-curable resin and a respective RI-matched photo-curable composition are almost identical, such that the presence of an RI-matched mineral reinforcing agent would not be expected to adversely affect printability of RI-matched photo-curable compositions. Mechanical analysis of molded samples obtained from the photo-curable resin and the respective RI-matched photo-curable composition also demonstrate that the presence of an RI-matched mineral reinforcing agent significantly increases the ultimate tensile strength and elastic modulus of a molded sample.

### Materials

A powdered (expanded and milled) aluminosilicate (perlite) (Phyllomat F™), supplied by Imerys, having a particle size (d₅₀) of 3.2 μm and a refractive index of 1.514 was used as a mineral reinforcing additive. A UV-curable urethane acrylate resin (MakerJuice G+™), purchased from MakerJuice Labs, having a refractive index of 1.4923 was used as a UV-curable resin. (3-acryloxypropyl)trimethoxysilane (96%), which was purchased from Gelest, Inc., was used as a surface modification agent. Deionized water was used as a co-solvent of a dispersing medium, and absolute ethanol (reagent grade, >99.8%), which was purchased from Sigma-Aldrich, was used as a co-solvent of the dispersing medium. Glacial acetic acid (pharma grade), which was purchased from Sigma-Aldrich, was used as an acid reagent. A Form 2A Opacity Chart, which was purchased from Leneta Company, Inc., was used in the qualitative measurement of opacity and haze.

Evaluating the Opacity of a RI-Matched Photo-Curable Resin Composition

To test whether use of a RI-matched reinforcing additive could lead to a photo-curable resin composition suitable for additive manufacturing, an RI-matched photo-curable resin composition was formed by combining a UV-curable resin (MakerJuice G+™) with a RI-matched mineral reinforcing additive, and the opacity of the RI-matched photo-curable resin composition was compared to the opacity of the UV-curable composition.

A commercially-obtained UV-curable resin (MakerJuice G+™) having a refractive index of 1.4923 was used as the UV-curable resin composition. A finely powdered (d₅₀=3.2 μm) aluminosilicate, having a refractive index of 1.514 and obtained from an expanded and milled perlite (Phyllomat F™), was used as the mineral reinforcing additive. The ratio of the refractive index of the reinforcing additive (perlite, 1.514) to the refractive index of the UV-curable resin (MakerJuice G+™, 1.4923) was 1.015. Therefore, the reinforcing additive was refractive index matched to the UV-curable resin. An RI-matched photo-curable resin composition was prepared by mixing the RI-matched reinforcing additive (Phyllomat F™) with the UV-curable resin (MakerJuice G+™) using a SpeedMixer for 2 minutes at 3000 rpm. The resulting RI-matched photo-curable resin composition A was homogeneously distributed and contained 17.8 wt. % of the perlite relative to a total weight of the composition A.

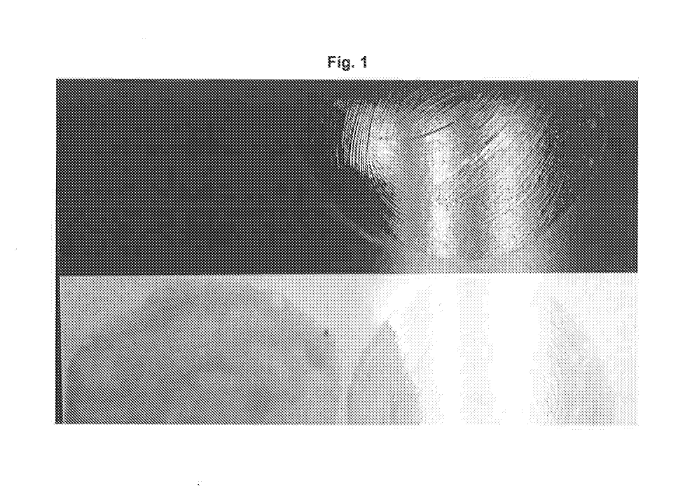

The distribution and scattering of the RI-matched photo-curable resin composition A was evaluated by comparing its physical appearance to that of the UV-curable resin (MakerJuice G+™) on a LENETA™ chart. The RI-matched photo-curable composition A and the MakerJuice G+™ were separately applied to different portions of the Leneta Form 2A Opacity Chart shown in FIG. 1. The MakerJuice G+™ was applied to the lower-left portion of the Leneta Chart in FIG. 1, while the RI-matched photo-curable resin composition A was applied to the lower-right and upper-right portions of the Leneta Chart in FIG. 1.

As shown in FIG. 1, comparing the left versus right sides of the Leneta Chart shows that the RI-matched photo-curable resin composition A (right side) exhibits less haze and is significantly more glossy compared to the MakerJuice G+™ (left side). The absence of haze in the residue of the RI-matched photo-curable resin composition A (right side) occurs because the high degree of refractive index matching between the aluminosilicate (RI=1.514) and the MakerJuice G+™ (RI=1.4923), ratio=1.015 (1.5% difference), leads to less scattering of the white light being applied to, and reflected from, the Leneta Chart in FIG. 1.

Preparing a Surface-Modified, RI-Matched Reinforcing Additive

A surface-modified reinforcing additive was prepared by reacting the RI-matched perlite described above (Phyllomat F™) with a surface modifying agent comprising an acrylate-containing silane compound.

2 grams of (3-acryloxypropyl)trimethoxysilane (95%) was mixed with 38 grams of a dispersing medium containing a 9:1 ethanol/water mixture to form a resulting mixture. To the resulting mixture was added 20 μL of glacial acetic acid, and the resulting solution was allowed to stand for 1 hour at 20° C. to obtain a surface modifying agent B.

The surface modifying agent B was mixed with the RI-matched aluminosilicate reinforcing additive (Phyllomat F™) described above, and the resulting mixture was homogenized using a Readco Kurimoto, LLC mixer at a 35 rpm tumble speed and a 3,500 rpm impeller speed for 10 minutes, to form a homogenized mixture. The homogenized mixture was then dried for 2 hours at 110° C. to obtain a surface-modified reinforcing additive C that was refractory indexed matched to MakerJuice G+™. The ratio of the refractive index of the surface-modified reinforcing additive C (perlite, 1.514) to the refractive index of the UV-curable resin (MakerJuice G+™, 1.4923) was about 1.015.

### Evaluating the Curing Rate of an RI-Matched Photo-Curable Resin Composition

The curing rates of MakerJuice G+™ and a RI-matched photo-curable resin composition based on MakerJuice G+™ were compared to determine whether the presence of the RI-matched reinforcing additive in the inventive resin composition would adversely affect the photo-curing process.

An RI-matched photo-curable resin composition was prepared by mixing the surface-modified reinforcing additive C described above with the UV-curable resin (MakerJuice G+™) using a SpeedMixer for 2 minutes at 3000 rpm. The resulting RI-matched photo-curable resin composition D was homogeneously distributed and contained about 10 wt. % of the surface-modified perlite relative to a total weight of the composition D.

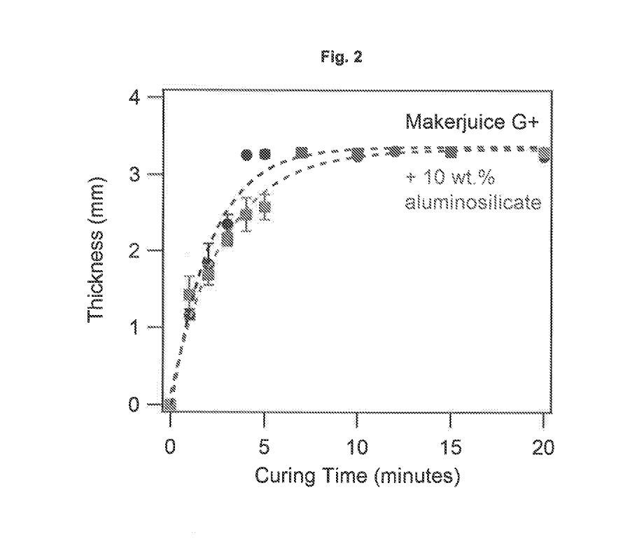

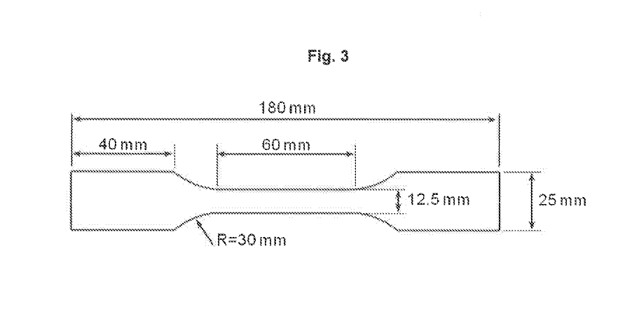

In separate experiments, a sample of MakerJuice G+™ was placed in a 3.3 mm-thick dog bone-shaped mold and was cured with a 36 watt UV lamp over a period of 20 minutes, and the RI-matched photo-curable resin composition D was placed in a 3.3 mm-thick dog bone-shaped mold and was cured with a 36 watt UV lamp over a period of 20 minutes. The thicknesses of the resulting cured samples as a function of the curing time are plotted in FIG. 2, and the dimensions of the 3.3 mm-thick dog bone-shaped mold (as viewed from the top) is depicted in FIG. 3. The error bars in FIG. 2 were generated by measuring the thickness of the resulting dog bone samples at three different positions of the dog bone samples. For the studies in FIG. 2, a sample thickness of 3.3 mm represents 100% curing. As shown in FIG. 2, the respective curing rates for the sample of MakerJuice G+™ (measurement points indicated by the dots “•”) and the sample of the RI-matched resin composition D based on MakerJuice G+™ (measurement points indicated by the boxes “▪”) were very similar. In both sets of experiments, it was observed that the thickness of both of the samples increased in a manner predicted for typical radical polymerizations (i.e., first order kinetics) of acrylate-based photo-curable resins. Furthermore, given that the thicknesses of the samples with and without the presence of the RI-matched aluminosilicate were within about 10% of one another throughout the course of the curing process, it is expected that the use of RI-matched photo-curable resin composition D would not adversely impact the performance of an additive manufacturing process based on stereolithography, 3D inkjet printing or digital light processing.

### Evaluating the Effect of the RI-Matched Reinforcing Additive on the Mechanical Properties of UV-Cured Composite Materials

The mechanical properties of UV-cured composite materials formed with and without the presence of an RI-matched reinforcing additive were measured to determine the effect of the RI-matched reinforcing additive.

In separate experiments, a sample of MakerJuice G+™ was place in a 3.3 mm-thick dog bone-shaped mold and was cured with a 36 watt UV lamp over a period of 20 minutes to form a Reference Example 1, and the RI-matched photo-curable resin composition D (prepared using 10 wt. % of the surface-modified perlite) was placed in a 3.3 mm-thick dog bone-shaped mold and was cured with a 36 watt UV lamp over a period of 20 minutes to form an Inventive Example 2. The dimensions of the 3.3 mm-thick dog bone-shaped molds (as viewed from the top) are depicted in FIG. 3. In each of Reference Example 1 and Inventive Example 2, five different samples were cured in order to obtain averaged property measurements and statistical data for each example.

The mechanical properties of the Reference Example 1 and the Inventive Example 2 were measured using an Instron 3367™ tensile test machine equipped with 2716-015 series wedge action grips at a rate of 4 mm per minute. The resulting data are shown in Table 1 below.

TABLE 1
Mechanical properties of UV-cured Samples

| | | | Tensile | Tensile | |
|---|---|---|---|---|---|
| | | Mineral | Strain at | Stress at | Young's |
| | | Content | Break | Break | Modulus |
| Sample | Material | (wt. %) | (%) | (MPa) | (MPa) |
| Reference | MakerJuice G+ | 0 | 3.06 ± | 34.3 ± | 1744 ± |
| Example 1 | | | 0.97 | 2.0 | 64 |
| Inven tive | MakerJuice G+ with | 10.0 | 2.47 ± | 37.2 ± | 2113 ± |
| Example 2 | 10 wt. % engineered | | 0.32 | 2.8 | 102 |
| | aluminosilicate | | | | |

As illustrated in Table 1 above, including 10 wt. % of the surface-modified reinforcing additive C (formed from an RI-matched aluminosilicate (perlite)) in the MakerJuice G+ significantly increased both the tensile stress at break and the Young's Modulus.

Given that the presence of the RI-matched aluminosilicate (perlite) did not adversely affect the curing rate during the formation of the cured product, relative to the curing rate of MakerJuice G+™ by itself, it is expected that the use of RI-matched reinforcing additives could profoundly improve the properties of articles formed using additive manufacturing techniques.

The above description is presented to enable a person skilled in the art to make and use the invention, and is provided in the context of a particular application and its requirements. Various modifications to the embodiments disclosed herein will be readily apparent to those skilled in the art, and the generic principles defined herein may be applied to other embodiments and applications without departing from the spirit and scope of the invention. Thus, this invention is not intended to be limited to the embodiments shown, but is to be accorded the widest scope consistent with the principles and features disclosed herein. In this regard, certain embodiments within the disclosure may not show every benefit of the invention, considered broadly.

1. A refractive index-matched photo-curable composition, comprising:
a photo-curable resin; and
a refractive index-matched additive,
wherein a ratio of a refractive index of the additive to a refractive index of the photo-curable resin ranges from about 0.8:1 to about 1.2:1.

2-4. (canceled)

5. The composition of claim 1, wherein the additive is at least one selected from the group consisting of a silica, an alumina, a gypsum, a talc, a mica, a montmorillonite mineral, a chalk, a diatomaceous earth, bauxite, limestone, sandstone, an aerogel, a xerogel, a microsphere, a porous ceramic sphere, gypsum dihydrate, calcium aluminate, magnesium carbonate, a ceramic material, a pozzolanic material, a zirconium compound, a xonotlite, a calcium silicate, a perlite, a vermiculite, a hydrated or unhydrated hydraulic cement particle, a pumice, a zeolite, a kaolin, calcium phosphate, barium sulfate, sodium carbonate, magnesium sulfate, aluminum sulfate, magnesium carbonate, barium carbonate, calcium oxide, magnesium oxide, calcium sulfate, barium sulfate, lithium fluoride, and calcium carbonate.

6-7. (canceled)

8. The composition of claim 1, wherein the additive is an aluminosilicate.

9. The composition of claim 8, wherein the aluminosilicate is perlite.

10. The composition of claim 1, wherein the additive is a refractive index-matched mineral.

11. The composition of claim 1, wherein the additive is a surface-modified mineral that is refractive index matched to the photo-curable resin.

12. The composition of claim 11, wherein the surface-modified mineral is an engineered aluminosilicate formed by reacting an acrylate-functional silane with an aluminosilicate that is refractive index matched to the photo-curable resin.

13-14. (canceled)

15. The composition of claim 1, wherein the additive has a median particles size (d50) ranging from about 1 μm to about 100 μm.

16. (canceled)

17. The photo-curable composition of claim 1, wherein the photo-curable resin comprises a pre-polymer mixture comprising:
an initiator;
a monomer, a macromer, or a mixture thereof, and
optionally at least one additional additive.

18-24. (canceled)

25. The composition of claim 17, wherein the pre-polymer mixture comprises at least one photoinitiator selected from the group consisting of benzophenone, methyl benzophenone, a xanthone, an acylphosphine oxide, a benzoin compound and a benzoin alkyl ether compound.

26. (canceled)

27. The composition of claim 1, wherein the ratio of the refractive index of the additive to the refractive index of the photo-curable resin ranges from about 0.9:1 to about 1.1:1.

28. The composition of claim 1, wherein the ratio of the refractive index of the additive to the refractive index of the photo-curable resin ranges from about 0.95:1 to about 1.05:1.

29. The composition of claim 1, wherein the refractive index of the additive ranges from about 1.2 to about 1.8.

30. The composition of claim 1, wherein the refractive index of the photo-curable resin ranges from about 1.2 to about 1.8.

31-33. (canceled)

34. An article obtained by polymerizing the composition of claim 1.

35. An additive-manufacturing process, comprising:
delivering the refractive index-matched photo-curable composition of claim 1 onto a working surface to obtain a pre-polymer deposit on the working surface; and
applying photons to the pre-polymer deposit to obtain a polymer in the form of a section plane of a component.

36-37. (canceled)

38. The process of claim 35, further comprising:
repeating the delivering and applying steps for successive section planes to fabricate the component.

39. The process of claim 35, comprising:
delivering a plurality of the refractive index-matched photo-curable composition onto the working surface to obtain a multi-composition deposit on the working surface; and
concurrently or sequentially applying a series of laser energies to the multi-composition deposit to obtain a plurality of polymers together forming the section plane of the component, in which the shapes and the contents of the section plane are defined at least in part by respective shapes and contents of the multi-component deposit,
wherein the series of laser energies includes a first laser energy of a first intensity applied to a first pre-polymer deposit, and a second laser energy of a second laser intensity applied to a second pre-polymer deposit.

40. The process of claim 39, further comprising:
repeating the delivering and applying steps for successive section planes to fabricate the component.

41. The process of claim 35, comprising:
delivering a plurality of the refractive index-matched photo-curable composition onto the working surface to obtain a multi-composition deposit on the working surface; and
applying the photons to the multi-composition deposit to obtain a plurality of polymers together forming the section plane of the component, in which the shapes and the contents of the section plane are defined at least in part by respective shapes and contents of the multi-component deposit,
wherein:
the multi-composition deposit includes a first photo-curable composition and a second photo-curable composition delivered to first and second areas on the working surface, said first and second areas optionally being in contact; and
respective ratios of the refractive indexes of the additives to the refractive indexes of the photo-curable resins in the first and second photo-curable compositions are different, such that respective intensities of photons penetrating the first and second photo-curable compositions on the working surface are different.

42-150. (canceled)
